(19) United States
(12) Patent Application Publication
(10) Pub. No.: US 2024/0424529 A1
(43) Pub. Date: Dec. 26, 2024

(54) ULTRASONIC SENSOR WITH TUNABLE METAL LAYER THICKNESS TO MATCH ULTRASONIC FREQUENCY

(71) Applicant: QUALCOMM Incorporated, San Diego, CA (US)

(72) Inventors: Chin-Jen TSENG, Fremont, CA (US); Jessica Liu STROHMANN, Cupertino, CA (US); Ila BADGE, San Jose, CA (US); Michelle Ma Thin Thin Htay CHAN, San Francisco, CA (US)

(21) Appl. No.: 18/339,878

(22) Filed: Jun. 22, 2023

(51) Int. Cl. B06B 1/06; G06V 40/13

(52) U.S. Cl. CPC B06B 1/0611; G06V 40/1306; B06B 2201/40

(57) ABSTRACT

An apparatus includes an ultrasonic sensor stack configured to transmit and receive ultrasonic waves. The ultrasonic sensor stack includes at least a thin film transistor layer, a piezoelectric layer, and a thin electrode layer. The ultrasonic sensor stack further includes a tunable metal layer coupled to the thin electrode layer and an acoustic layer coupled to the tunable metal layer, where the tunable metal layer has a thickness greater than a thickness of the thin electrode layer. The thickness of the tunable metal layer may be configured to match a peak frequency in an ultrasonic frequency range of the ultrasonic waves transmitted by the ultrasonic sensor stack. In some implementations, the tunable metal layer includes a copper layer and the acoustic layer includes polyimide or polyethylene terephthalate.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in its entirety and for all purposes.

### TECHNICAL FIELD

This disclosure relates generally to sensor devices and related methods, including but not limited to ultrasonic sensor systems and methods for using such systems.

### DESCRIPTION OF THE RELATED TECHNOLOGY

Biometric authentication can be an important feature for controlling access to devices, etc. Many existing products include some type of biometric authentication. Although some existing biometric authentication technologies provide satisfactory performance, improved methods and devices would be desirable.

### SUMMARY

The systems, methods and devices of the disclosure each have several innovative aspects, no single one of which is solely responsible for the desirable attributes disclosed herein.

One innovative aspect of the subject matter described in this disclosure may be implemented in an apparatus. The apparatus includes an ultrasonic sensor stack configured to transmit and receive ultrasonic waves. The ultrasonic sensor stack includes a transistor layer having a substrate and an array of sensor pixels, a piezoelectric layer coupled to the transistor layer, an electrode layer coupled to the piezoelectric layer, and a metal layer coupled to the electrode layer, where the metal layer has a thickness tuned to match a peak frequency in an ultrasonic frequency range of the ultrasonic waves transmitted by the ultrasonic sensor stack.

In some implementations, the apparatus further includes a device stack selected from the group consisting of: a display stack, a glass stack, a plastic stack, a ceramic stack, and a metal stack, wherein the ultrasonic sensor stack is underlying the device stack. In some implementations, the device stack includes the display stack. In some implementations, the display stack includes a display stiffener coupled to a foldable display, wherein an acoustic resonator is formed by at least the display stiffener, the transistor layer, the piezoelectric layer, the electrode layer, and the metal layer. In some implementations, a thickness of the acoustic resonator corresponds to a multiple N of a half wavelength (N*λ/2) of the peak frequency in the ultrasonic frequency range of the ultrasonic waves transmitted by the ultrasonic sensor stack, wherein N is an integer greater than or equal to 1. In some implementations, the apparatus further includes an adhesive between the display stiffener and the ultrasonic sensor stack, and a matching layer between the adhesive and the display stiffener, wherein the matching layer has an acoustic impedance value greater than the adhesive and less than the display stiffener. In some implementations, the electrode layer has a thickness equal to or less than about 10 μm. In some implementations, the metal layer comprises a copper layer. In some implementations, a thickness of the copper layer is between about 1 μm and about 120 μm and a peak frequency in the ultrasonic frequency range is between about 2 MHz and about 20 MHz. In some implementations, a thickness of the copper layer is between about 2 μm and about 18 μm and the peak frequency in the ultrasonic frequency range is between about 10 MHz and about 18 MHz. In some implementations, a thickness of the copper layer is between about 20 μm and about 80 μm and the peak frequency in the ultrasonic frequency range is between about 3 MHz and about 10 MHz. In some implementations, the electrode layer comprises silver ink or silver paste. In some implementations, the apparatus further includes an acoustic layer coupled to the metal layer, where the acoustic layer includes a material having an acoustic impedance value that is less than an acoustic impedance value of the metal layer. In some implementations, a thickness of the acoustic layer is tuned to optimize amplification of a signal of the ultrasonic waves. In some implementations, the acoustic layer comprises polyimide (PI) or polyethylene terephthalate (PET). In some implementations, the apparatus further includes a conductive film layer between the metal layer and the electrode layer, where the conductive film layer provides electrical interconnection between the metal layer and the electrode layer, and a polyimide layer coupled to the metal layer, where the metal layer comprises a copper layer, where the copper layer and the polyimide layer collectively form a flexible copper clad laminate (FCCL) stack. In some implementations, the substrate includes silicon, glass or plastic. In some implementations, the piezoelectric layer is coupled to the transistor layer on a side of the transistor layer facing towards the display stack. In some implementations, the piezoelectric layer is coupled to the transistor layer on a side of the transistor layer facing away from the display stack. In some implementations, the thickness of the metal layer is greater than a thickness of the electrode layer.

Other innovative aspects of the subject matter described in this disclosure may be implemented in an apparatus. The apparatus includes a foldable display stack comprising display stiffener, and an ultrasonic sensor stack configured to transmit and receive ultrasonic waves. The ultrasonic sensor stack includes a transistor layer having a substrate and an array of sensor pixels, a piezoelectric layer coupled to the transistor layer, a silver ink electrode layer coupled to the piezoelectric layer, a tunable copper layer coupled to the silver ink electrode layer, where a thickness of the tunable copper layer is greater than a thickness of the silver ink electrode layer, where an acoustic resonator is formed by at least the display stiffener, the transistor layer, the piezoelectric layer, the silver ink electrode layer, and the tunable copper layer, and a polyimide layer coupled to the tunable copper layer.

In some implementations, the ultrasonic sensor stack further includes an anisotropic conductive film (ACF) layer between the tunable copper layer and the silver ink electrode layer, where the tunable copper layer and the polyimide layer form a flexible copper clad laminate (FCCL) stack. In some implementations, a thickness of the acoustic resonator corresponds to a multiple N of a half wavelength (N*λ/2) of a peak frequency in an ultrasonic frequency range of the ultrasonic waves transmitted by the ultrasonic sensor stack, where N is an integer greater than or equal to 1.

Other innovative aspects of the subject matter described in this disclosure may be implemented in a method. The method includes controlling, via a control system, an ultrasonic transceiver layer of an ultrasonic fingerprint sensor stack to transmit ultrasonic waves through at least one or more display stack layers of a foldable display, where the ultrasonic fingerprint sensor stack comprises a transistor layer having a substrate and an array of sensor pixels, the ultrasonic transceiver layer coupled to the transistor layer, an electrode layer coupled to the ultrasonic transceiver layer, and a metal layer coupled to the electrode layer. The method further includes receiving, by the control system and from the ultrasonic fingerprint sensor stack, ultrasonic sensor signals corresponding to reflections of transmitted ultrasonic waves from a portion of a target object positioned on an outer surface of an apparatus that includes the ultrasonic fingerprint sensor stack. The method further includes performing, by the control system, an authentication process based, at least in part, on the ultrasonic sensor signals.

In some implementations, the electrode layer has a thickness equal to or less than about 10 μm and a local maximum of ultrasonic wave transmission corresponds to a frequency in a range from 1 MHz to 20 MHz. In some implementations, the authentication process involves extracting target object features from the ultrasonic sensor signals. In some implementations, the target object features include at least one of fingerprint features or sub-epidermal features.

### BRIEF DESCRIPTION OF THE DRAWINGS

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale. Like reference numbers and designations in the various drawings indicate like elements.

FIG. 1 is a block diagram that shows example components of an apparatus including a foldable display stack and an ultrasonic sensor stack.

FIG. 2 shows a cross-sectional schematic view of an example apparatus including a foldable display stack and an ultrasonic sensor stack.

FIG. 3 shows a cross-sectional schematic view of an example apparatus including a display stack and an ultrasonic sensor stack with a thick electrode layer according to some implementations.

FIG. 4 shows a cross-sectional schematic view of an example apparatus including an ultrasonic sensor stack with a tunable metal layer according to some disclosed implementations.

FIG. 5A shows a cross-sectional schematic view of an example apparatus including a device stack, an ultrasonic sensor stack in a “receiver down” orientation and having a thin electrode layer, and a tunable metal stack according to some disclosed implementations.

FIG. 5B shows a cross-sectional schematic view of an example apparatus including a device stack, an ultrasonic sensor stack in a “receiver down” orientation and having a thin electrode layer, a matching layer between the device stack and the ultrasonic sensor stack, and a tunable metal stack according to some disclosed implementations.

FIG. 5C shows a cross-sectional schematic view of an example apparatus including a device stack, an ultrasonic sensor stack in a “receiver up” orientation and having a thin electrode layer, and a tunable metal stack according to some disclosed implementations.

FIG. 6 shows a cross-sectional schematic view of an example apparatus including display stack layers, and an under-display ultrasonic sensor system with a silver ink electrode layer and a tunable copper layer according to some disclosed implementations.

FIG. 7 shows a flow diagram of an example method of operating an apparatus for user authentication according to some disclosed implementations.

FIG. 8 representationally depicts aspects of a 4×4 pixel array of sensor pixels for an ultrasonic sensor system according to some disclosed implementations.

### DETAILED DESCRIPTION

The following description is directed to certain implementations for the purposes of describing the innovative aspects of this disclosure. However, a person having ordinary skill in the art will readily recognize that the teachings herein may be applied in a multitude of different ways. The described implementations may be implemented in any device, apparatus, or system that includes a biometric system as disclosed herein. In addition, it is contemplated that the described implementations may be included in or associated with a variety of electronic devices such as, but not limited to: mobile telephones, multimedia Internet enabled cellular telephones, mobile television receivers, wireless devices, smartphones, smart cards, wearable devices such as bracelets, armbands, wristbands, rings, headbands, patches, etc., Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), mobile health devices, computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also may be used in applications such as, but not limited to, electronic switching devices, radio frequency filters, sensors, accelerometers, gyroscopes, motion-sensing devices, magnetometers, inertial components for consumer electronics, parts of consumer electronics products, steering wheels or other automobile parts, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Fingerprint sensor systems may be useful and effective in authenticating users to electronic devices. Capacitive-based fingerprint sensors may require electromagnetic signals that can interfere with the electrical functions of the display. Signals generated or transferred within the display along with associated conductive traces may reduce capacitive fingerprint-sensing capability. Optical-based fingerprint systems may be limited or rendered useless where display devices include a light-blocking layer or a large number of metal traces. Ultrasonic-based fingerprint sensors use ultrasonic waves to produce a detailed reproduction of a scanned fingerprint. An ultrasonic-based fingerprint sensor for fingerprint scanning may be incorporated in an electronic device. Ultrasonic-based fingerprint sensors may be incorporated “under display,” “under glass,” “under ceramic,” “under metal,” “under plastic,” or “under composite” so that fingerprint scans may be performed. Ultrasonic-based fingerprint sensors maybe incorporated in internet of things (IoT) applications, personal computing (PC) and mobile applications, display applications, smart appliance applications, door lock applications, bicycle applications, and automobile and motorcycle applications, among other possible applications.

Some display devices include flexible or foldable display devices. For instance, a foldable display device may include a flexible organic light-emitting diode (OLED) display device.

Stack-ups in ultrasonic sensor systems ordinarily include a thin film transistor (TFT) layer, a piezoelectric layer, and an electrode layer. The electrode layer serves as metallization for a receiver, transmitter, or transceiver electrode. The electrode layer often includes metallization such as silver (Ag) in a polymer matrix such as silver ink, silver paste or epoxy, or polyurethane (AgUr). Silver paste may include silver particles in an epoxy. Silver ink may be pure silver without particles, whereby pure silver is formed in reduction processes. Silver ink can be readily synthesized and exhibits high electrical conductivity and resistance to oxidation. Silver ink can be printed using processes such as inkjet printing or screen printing.

Ultrasonic sensor systems are configured to transmit ultrasonic waves at frequencies between about 1 MHz and about 20 MHz with wavelengths on the order of a quarter millimeter or less. An ultrasonic sensor system may be configured to transmit and receive ultrasonic waves having relatively higher peak frequencies that are 10 MHz or greater. Alternatively, an ultrasonic sensor system may be configured to transmit and receive ultrasonic waves having relatively lower peak frequencies that are less than 10 MHz. In some instances involving foldable displays, optimal transmission of ultrasonic waves may occur in a frequency range between about 5 MHz and about 10 MHz, between about 5 MHz and about 8 MHz, or between about 7 MHz and about 8 MHz. In some instances, it may be desirable to operate at an ultralow frequency range less than or equal to 5 MHz, or between about 3 MHz and about 5 MHz.

The thickness of the silver ink or silver paste in the electrode layer is typically tuned to match the peak frequency associated with the ultrasonic sensor system of the display device. In other words, the electrode layer of the ultrasonic sensor system is generally responsible for frequency tuning. As the peak frequencies in an ultrasonic frequency range become lower and lower (e.g., less than about 10 MHz), it may be necessary for the silver ink or silver paste in the electrode layer to be thicker to match the peak frequency associated with the ultrasonic sensor system of the display device. However, it becomes increasingly more challenging to print silver ink uniformly using screen printing technologies as the silver ink becomes thicker. By way of an example, if the thickness of silver ink (e.g., 40 μm or more) requires many layers of printing (e.g., 3 or more layers), the thickness variations become increasingly worse as the layers of silver ink are stacked up. This results in reduced device performance, poor yield, and high cost of manufacturing.

A device of the present disclosure includes a tunable metal layer responsible for frequency tuning in the ultrasonic sensor system. The tunable metal layer may be coupled to an electrode layer of the ultrasonic sensor system, where the tunable metal layer has a thickness tuned to match a peak frequency in an ultrasonic frequency range of ultrasonic waves transmitted by the ultrasonic sensor system. The tunable metal layer may be thicker than the electrode layer. In some implementations, the tunable metal layer comprises a copper layer. In some implementations, the electrode layer comprises silver that may be in the form of silver ink or silver paste, where a thickness of the electrode layer is equal to or less than about 10 μm. In some implementations, the tunable metal layer is coupled to an acoustic layer having an acoustic impedance value less than the tunable metal layer. The acoustic layer may be composed of polyimide or polyethylene terephthalate. In some cases, the layer of polyimide and the copper layer of the tunable metal layer may collectively form a flexible clad copper laminate (FCCL) stack. A thickness of the acoustic layer may be configured to amplify the signal of the ultrasonic waves. The ultrasonic sensor system may be oriented in a “receiver up” or “receiver down” orientation, and the ultrasonic sensor system may include an ultrasonic transceiver in some implementations, or an ultrasonic transmitter separate from an ultrasonic receiver in some other implementations.

Particular implementations of the subject matter described in this disclosure may be implemented to realize one or more of the following potential advantages. Incorporation of a tunable metal layer that is separate from the electrode layer for frequency tuning improves performance of the device. Specifically, the device may operate at frequencies less than about 10 MHz or even less than about 7 MHz. At such low frequencies, a tunable metal layer such as a copper layer may be introduced for frequency tuning without compromising image quality and reliability of the ultrasonic sensor system. The thickness of the electrode layer is reduced accordingly to reduce the cost of manufacturing and to minimize its adverse effect on imaging. The tunable metal layer can be easily tuned to wide range of thicknesses so that the frequency can be easily tuned across a wider range of ultrasonic frequencies (e.g., between 1 MHz and 20 MHz). The tunable metal layer may be cost-effective or at least more cost-effective than increasing a thickness of an electrode layer. For example, a copper layer and layer of polyimide in an FCCL stack may be cost-efficient and easy to implement in a device. Thus, the tunable metal layer coupled to the acoustic layer may be less complex to manufacture than a thick electrode layer in a device. Furthermore, the copper layer and layer of polyimide in an FCCL stack may improve image quality, such as making the background image more uniform. For instance, the background image may have less pixel-to-pixel gray level difference and fewer defects.

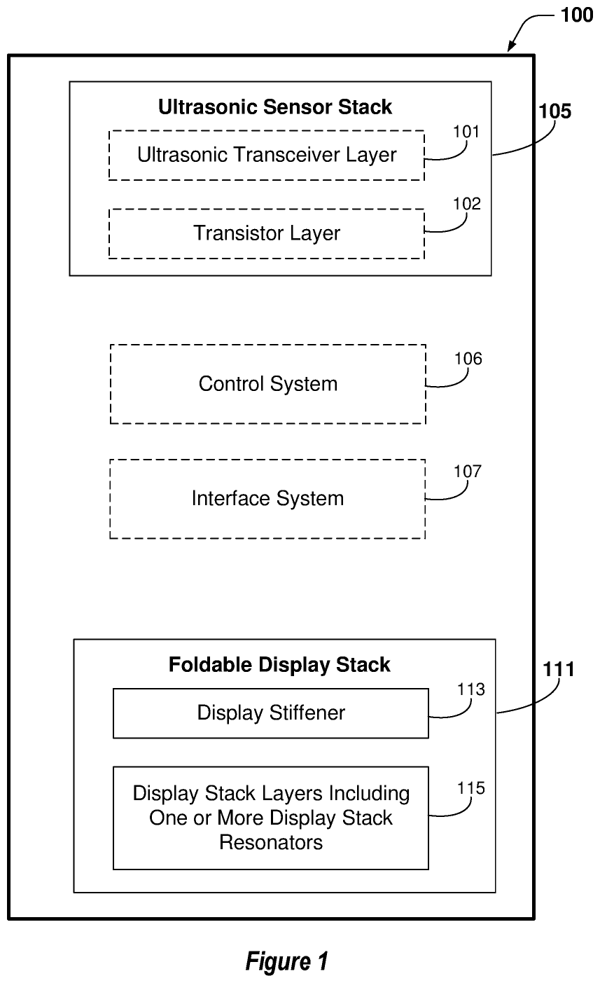

FIG. 1 is a block diagram that shows example components of an apparatus including a foldable display stack and an ultrasonic sensor stack. As with other disclosed implementations, the numbers, types and arrangements of elements shown in FIG. 1 are merely presented by way of example. Although not shown in FIG. 1, the apparatus 100 may include other components, such as a cover (which may be, or may include, a cover glass), one or more adhesive layers, one or more electrode layers, etc. Some examples are described below. In some implementations, the apparatus 100 may be a mobile device that includes the elements shown in FIG. 1.

According to this example, the apparatus 100 includes an ultrasonic sensor stack 105. The ultrasonic sensor stack 105 is configured to transmit and receive ultrasonic waves. In some examples, the ultrasonic sensor stack 105 includes an ultrasonic transceiver layer 101 and a transistor layer 102. The transistor layer 102 may include a transistor substrate such as a TFT substrate and an array of sensor pixels. In some examples, the ultrasonic transceiver layer 101 may be configured to function as both an ultrasonic transmitter and an ultrasonic receiver. According to some implementations, the ultrasonic transceiver layer 101 may be a single piezoelectric layer. According to some other implementations, the ultrasonic transceiver layer 101 may be a multi-layer piezoelectric structure, or an array of such structures. For example, the ultrasonic transceiver layer 101 may include an ultrasonic transmitter layer separate from an ultrasonic receiver layer.

In some implementations, the ultrasonic transceiver layer 101 may include a piezoelectric layer, such as a layer of PVDF polymer or a layer of PVDF-TrFE copolymer. In some implementations, other piezoelectric materials may be used in the ultrasonic transceiver layer 101, such as aluminum nitride (AlN) or lead zirconate titanate (PZT). Some alternative implementations may include separate ultrasonic transmitter and ultrasonic receiver layers.

The ultrasonic transceiver layer 101 may, in some alternative examples, include an array of ultrasonic transducer elements, such as an array of piezoelectric micromachined ultrasonic transducers (PMUTs), an array of capacitive micromachined ultrasonic transducers (CMUTs), etc. In some such examples, a piezoelectric receiver layer, PMUT elements in a single-layer array of PMUTs, or CMUT elements in a single-layer array of CMUTs, may be used as ultrasonic transmitters as well as ultrasonic receivers.

The transistor layer 102 may be a type of metal-oxide-semiconductor field-effect transistor (MOSFET) made by depositing thin films of an active semiconductor layer as well as a dielectric layer and metallic contacts over a transistor substrate. In some examples, the transistor substrate may be a non-conductive material such as glass. According to some implementations, the transistor layer 102 may have a thickness that is in the range of 50 μm to 400 μm.

In this implementation, the apparatus includes a foldable display stack 111. According to this example, the foldable display stack 111 includes a display stiffener 113 and display stack layers 115. The display stack layers 115 may, in some examples, include layers of a light-emitting diode (LED) display, such as an organic light-emitting diode (OLED) display. Some examples of display stack layers 115 are provided in this disclosure.

In this example, the display stack layers 115 form one or more display stack resonators. The display stack resonator(s) may, in some examples, be configured to enhance ultrasonic waves transmitted by the ultrasonic sensor stack in a first ultrasonic frequency range. In some examples, the one or more display stack resonators may include a first resonator bounded by the display stiffener 113 and a glass layer of the display stack layers 115. In some such examples, the first resonator may include a plurality of layers of an organic light-emitting diode display. In some examples, the one or more display stack resonators may include a second resonator bounded by the glass layer and an outer surface of the foldable display stack.

In some examples, the display stiffener 113 may have a relatively high acoustic impedance. Acoustic impedance values may be measured in Rayls or MRayls. Acoustic impedance values are a function of a medium's density multiplied by the speed of sound through the medium. Generally, metals, ceramics, and glasses may be considered to have high acoustic impedance values; plastics and polymers may be considered to have low acoustic impedance values; and air may be considered to have a very low acoustic impedance value. In one example, the display stiffener 113 may have an acoustic impedance of 10 MRayls or more. In some implementations, the display stiffener 113 may be, or may include, a metal layer. Such a metal layer may include a stainless steel layer having an acoustic impedance of approximately 47 MRayls or an aluminum layer having an acoustic impedance of approximately 17 MRayls. However, in other implementations the display stiffener 113 may be, or may include, one or more other metals, or non-metal material (e.g., plastic) having a relatively high modulus of elasticity. According to some examples, the display stiffener 113 may have a thickness in the range of 30 μm to 300 μm. According to some examples, the display stiffener 113 may have a thickness corresponding to a multiple of a half wavelength of a shear wave or a longitudinal wave having a frequency in a second ultrasonic frequency range that is higher than the first ultrasonic frequency range.

In some examples, the apparatus 100 may include a control system 106. The control system 106 (when present) may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. The control system 106 also may include (and/or be configured for communication with) one or more memory devices, such as one or more random access memory (RAM) devices, read-only memory (ROM) devices, etc. Accordingly, the apparatus 100 may have a memory system that includes one or more memory devices, though the memory system is not shown in FIG. 1. The control system 106 may be capable of receiving and processing data from the ultrasonic transceiver layer 101 and/or from an array of sensor pixels, e.g., as described below. In some implementations, functionality of the control system 106 may be partitioned between one or more controllers or processors, such as a dedicated sensor controller and an applications processor of a mobile device.

Some implementations of the apparatus 100 may include an interface system 107. In some examples, the interface system may include a wireless interface system. In some implementations, the interface system may include a user interface system, one or more network interfaces, one or more interfaces between the control system 106 and a memory system and/or one or more interfaces between the control system 106 and one or more external device interfaces (e.g., ports or applications processors).

The interface system 107 may be configured to provide communication (which may include wired or wireless communication, such as electrical communication, radio communication, etc.) between components of the apparatus 100. In some such examples, the interface system 107 may be configured to provide communication between the control system 106 and the ultrasonic transceiver layer 101, to provide communication between the control system 106 and one or more of the display stack layers 115, and/or to provide communication between the control system 106 and an array of sensor pixels. According to some such examples, a portion of the interface system 107 may couple at least a portion of the control system 106 to the ultrasonic transceiver layer 101 and/or an array of sensor pixels, e.g., via electrically conducting material.

According to some examples, the interface system 107 may be configured to provide communication between the apparatus 100 and other devices and/or human beings. In some such examples, the interface system 107 may include one or more user interfaces. The interface system 107 may, in some examples, include one or more network interfaces and/or one or more external device interfaces (such as one or more universal serial bus (USB) interfaces). In some implementations, the apparatus 100 may include a memory system. The interface system 107 may, in some examples, include at least one interface between the control system 106 and a memory system.

The apparatus 100 may be used in a variety of different contexts, many examples of which are disclosed herein. For example, in some implementations a mobile device, such as a cell phone, a smart phone, a tablet, a laptop (e.g., a laptop touchpad), etc., may include at least a portion of the apparatus 100. In some implementations, a wearable device may include at least a portion of the apparatus 100. The wearable device may, for example, be a watch, a bracelet, an armband, a wristband, a ring, a headband or a patch. In some implementations, the control system 106 may reside in more than one device. For example, a portion of the control system 106 may reside in a wearable device and another portion of the control system 106 may reside in another device, such as a mobile device (e.g., a smartphone or a tablet computer) and/or a server. The interface system 107 also may, in some such examples, reside in more than one device.

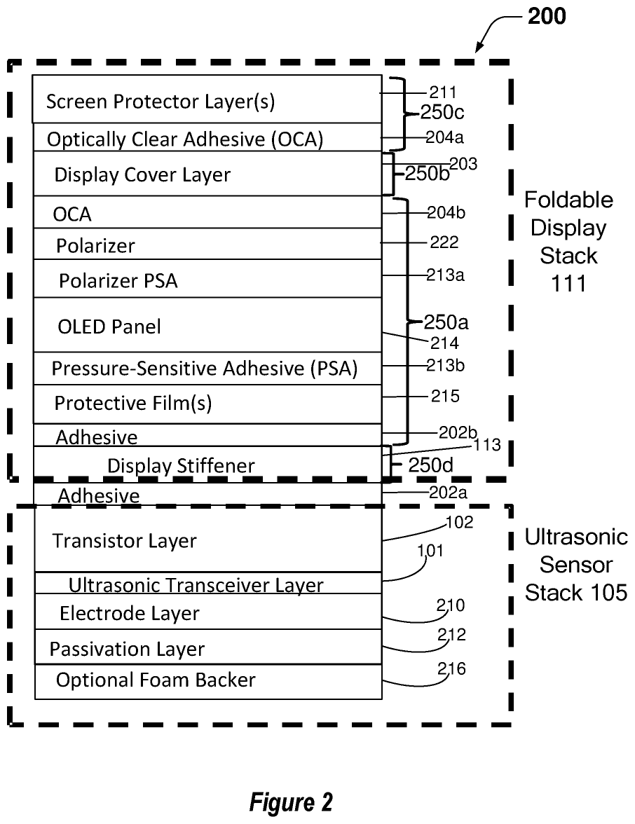

FIG. 2 shows a cross-sectional schematic view of an example display device including a foldable display stack and an ultrasonic sensor stack. The types, number and arrangement of elements shown in FIG. 2 are merely examples. Other examples may include different types, numbers and/or arrangements of elements. Moreover, the elements shown in FIG. 2 are not drawn to scale.

The apparatus 200 is similar to the apparatus 100 shown in FIG. 1. The apparatus 200 includes instances of the ultrasonic sensor stack 105 and of the foldable display stack 111 of FIG. 1. Here, the ultrasonic sensor stack 105 is attached to the foldable display stack 111 via an adhesive layer 202a. The adhesive layer 202a may be, or may include, a pressure-sensitive adhesive (PSA). In some instances, the adhesive layer 202a may be in the range of 2 μm to 10 μm.

The ultrasonic sensor stack 105 includes a transistor layer 102, an ultrasonic transceiver layer 101 and an electrode layer 210. The transistor layer 102 resides between the ultrasonic transceiver layer 101 and the foldable display stack 111, and the adhesive layer 202a connects the transistor layer 102 to the foldable display stack 111. In some alternative examples, the ultrasonic transceiver layer 101 may reside between the transistor layer 102 and the foldable display stack 111. The ultrasonic transceiver layer 101 may be, or may include, one or more piezoelectric materials, such as a piezoelectric polymer and/or a piezoelectric copolymer. The electrode layer 210 may be, or may include, an electrically conductive material such as a conductive ink. For example, the electrically conductive material may include silver ink. In this instance, the ultrasonic sensor stack 105 includes a passivation layer 212. The passivation layer 212 may be, or may include, an epoxy film.

The ultrasonic sensor stack 105 may optionally further include a foam backer 216. The foam backer 216 may be located at the bottom or back of the apparatus 200. The foam backer 216 may be underlying the passivation layer 212 of the ultrasonic sensor stack 105. In some implementations, the foam backer 216 may be composed of a soft flexible material. In some implementations, the foam backer 216 may be porous. The foam backer 216 at the back of the apparatus 200 may provide a mechanical cushion or support. This provides structural support and protection for the ultrasonic sensor stack 105. In some cases, the foam backer 216 may have an acoustic impedance very close to air in order to provide total or near-total reflection of propagating ultrasonic waves.

The foldable display stack 111 includes a display stiffener 113 that resides between the transistor layer 102 and the other layers of the foldable display stack 111. The display stiffener 113 provides structural support for the other layers of the foldable display stack 111. In some examples, the display stiffener 113 may be, or may include, a high-impedance material (in other words, a material having a high acoustic impedance) such as a metal.

The foldable display stack 111 includes one or more screen protector layers 211, which may include a polyethylene terephthalate (PET) layer in some instances. The foldable display stack 111 includes a display cover layer 203, a polarizer layer 222, an OLED panel 214 and one or more layers of protective film 215. The display cover layer 203 may include a glass, plastic, or other transparent material. Here, an optically clear adhesive (OCA) layer 204a connects the one or more screen protector layers 211 to the display cover layer 203 and an OCA layer 204b connects the display cover layer 203 to the polarizer layer 222. A polarizer pressure-sensitive adhesive 213a connects the polarizer 222 to the OLED panel 214 and a pressure-sensitive adhesive 213b connects the OLED panel 214 to the one or more layers of protective film 215. The polarizer pressure-sensitive adhesive 213a may, for example, be an optically clear adhesive (OCA).

In this example, the adhesive layer 202b and layers of the foldable display stack 111 form the resonator 250a, which is bounded by the display cover layer 203 and the display stiffener 113. According to this example, the resonator 250a includes the OCA layer 204b, the polarizer layer 222, the polarizer pressure-sensitive adhesive 213a, the OLED panel 214, the pressure-sensitive adhesive 213b, the one or more layers of protective film 215 and the adhesive layer 202b. In some examples, the thickness of the resonator 250a may correspond to a multiple N of a half wavelength at a peak frequency of an ultrasonic frequency range of ultrasonic waves transmitted by the ultrasonic sensor stack 105, where N is an integer greater than or equal to 1. In some such implementations, the resonator 250a may cause a local maximum within the ultrasonic frequency range. According to some examples, the local maximum may correspond to a frequency in the range from 5 MHz to 15 MHz, or from 1 MHz to 20 MHz. According to some such implementations, a frequency range that includes the local ultrasonic wave transmission maximum caused by the resonator 250a may correspond with a frequency range that includes a local ultrasonic wave transmission maximum caused by the resonator 250c.

According to this example, the foldable display stack 111 also includes the resonator 250c, which is formed by the one or more screen protector layers 211 and the OCA 204a, and is bounded by the display cover layer 203: here, the display cover layer 203 has a higher acoustic impedance than that of the one or more screen protector layers 211 or the OCA 204a. In some examples, the thickness of the resonator 250c may correspond to a multiple N of a quarter wavelength at a peak frequency of an ultrasonic frequency range of ultrasonic waves transmitted by the ultrasonic sensor stack 105, where N is an integer greater than or equal to 1. In some such implementations, the resonator 250c may cause a local maximum within the ultrasonic frequency range. According to some examples, the local maximum may correspond to a frequency in the range from 5 MHz to 15 MHz, or from 1 MHz to 20 MHz. According to some such implementations, a frequency range that includes the local ultrasonic wave transmission maximum caused by the resonator 250a may correspond with a frequency range that includes a local ultrasonic wave transmission maximum caused by the resonator 250c.

In this implementation, the display cover layer 203 forms a resonator 250b. According to some examples, the frequencies for maximum transmission of ultrasonic waves through the resonator 250b may be outside of (e.g., below) the frequency range that includes the local maxima caused by the resonators 250a and 250c. In some examples, the thickness of the resonator 250b may be less than a multiple N of a quarter wavelength at a peak frequency of an ultrasonic frequency range of ultrasonic waves transmitted by the ultrasonic sensor stack 105, where N is an integer greater than or equal to 1.

In this example, the display stiffener 113 forms the resonator 250d. According to this example, the resonator 250d causes a very low transmission of ultrasonic waves in the frequency range from 5 MHz to 15 MHz. The low transmission of ultrasonic waves caused by the display stiffener 113 may represent significant challenge for the design of under-display ultrasonic sensors.

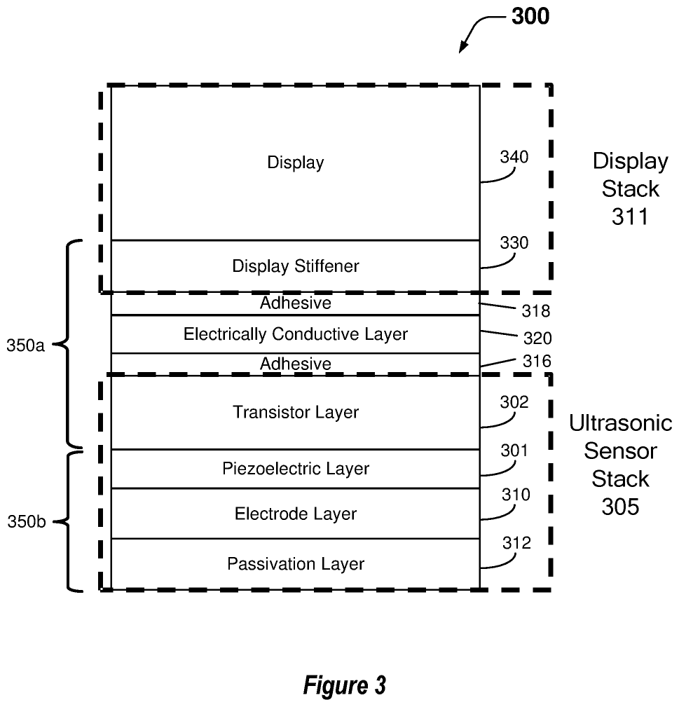

FIG. 3 shows a cross-sectional schematic view of an example apparatus including a display stack and an ultrasonic sensor stack with a thick electrode layer according to some implementations. As with other disclosed implementations, the types, number and arrangement of elements shown in FIG. 3 are merely examples. Other implementations may include different types, numbers and/or arrangements of elements. Moreover, the elements shown in FIG. 3 are not drawn to scale.

According to this example, an apparatus 300 includes a display stack 311 and an ultrasonic sensor stack 305. The ultrasonic sensor stack 305 may be underlying the display stack 311. The ultrasonic sensor stack 305 is configured to transmit and receive ultrasonic waves. The ultrasonic sensor stack 305 includes a transistor layer 302, where the transistor layer 302 may include a transistor substrate such as a TFT substrate and an array of sensor pixels. The transistor layer 302 may be a type of MOSFET made by depositing thin films of an active semiconductor layer as well as a dielectric layer and metallic contacts over a transistor substrate. In some implementations, the transistor substrate may include a non-conductive material such as glass or plastic. In some implementations, the transistor layer 302 may have a thickness that is in the range of 50 μm to 400 μm.

The ultrasonic sensor stack 305 further includes a piezoelectric layer 301. The piezoelectric layer 301 may be coupled to the transistor layer 302. The piezoelectric layer 301 may serve as an ultrasonic transmitter, ultrasonic receiver, or ultrasonic transceiver configured to transmit and receive ultrasonic waves. As a transmitter or transceiver, ultrasonic waves may be generated by applying a voltage across the piezoelectric layer 301 to expand or contract the layer, thereby generating a plane wave. A target object such as a finger may reflect back a portion of the ultrasonic waves. As a receiver or transceiver, the piezoelectric layer 301 may convert vibrations caused by reflections of the ultrasonic waves into electrical output signals. The electrical output signals may be provided to the array of sensor pixels for processing image data such as fingerprint image data.

Though the piezoelectric layer 301 is illustrated as a single piezoelectric layer, it will be understood that the piezoelectric layer 301 may be a multi-layer piezoelectric structure or an array of such structures. The piezoelectric layer 301 may include a piezoelectric material such as PVDF polymer or a layer of PVDF-TrFE copolymer. Other piezoelectric materials may be used such as AlN or PZT. In some implementations, a thickness of the piezoelectric layer 301 may be between about 5 μm and about 30 μm or between about 10 μm and about 20 μm.

In some implementations, the ultrasonic sensor stack 305 further includes an electrode layer 310 coupled to the piezoelectric layer 301. Ultrasonic waves may be generated by providing an electrical signal to the electrode layer 310 coupled to the piezoelectric layer 301. The electrode layer 310 may be, or may include, a conductive film such as silver ink or silver paste. Generally speaking, the electrode layer 310 is a thick metal layer. A thick metal layer may be sufficiently thick and made of a suitable metal for acoustic coupling with the ultrasonic sensor stack 305. In some implementations, a thickness of the electrode layer 310 such as a silver ink electrode layer is greater than about 5 μm, between about 10 μm and about 100 μm, or between about 20 μm and about 80 μm. This may be referred to as a “thick” electrode layer.

When depositing silver ink for an electrode layer 310, the silver ink may be screen printed with two or more layers. When adding more layers of silver ink, non-uniformities in thickness become larger and larger in screen printing, thereby resulting in greater thickness variations. These thickness variations adversely affect the performance of the apparatus 300. Additional costs and complexity in manufacturing may accompany any process of mitigating such thickness variations and other deformities.

In some implementations, the ultrasonic sensor stack 305 further includes a passivation layer 312. The passivation layer 312 may be coupled to the electrode layer 310. The passivation layer 312 may serve to electrically insulate and protect the electrode layer 310. In some implementations, the passivation layer 312 includes a photoresist, a photo-imageable epoxy, or other smooth electrically insulating material. According to some examples, the passivation layer 312 may be, or may include, an epoxy film. In some instances, the passivation layer 312 may have a thickness between about 10 μm and about 30 μm.

The apparatus 300 includes a display stack 311. The display stack 311 may include a display stiffener 330 and a display 340. In some implementations, the display 340 includes a foldable display. The display 340 may include one or more display layers such as one or more layers of an LED or OLED display. Examples of display layers are discussed above with reference to FIG. 2. The display stiffener 330 may be, or may include, a high-impedance material such as a metal. In some examples, the display stiffener 330 may have an acoustic impedance value greater than about 5.0 MRayls, greater than about 8.0 MRayls, or greater than about 10.0 MRayls. In some implementations, the display stiffener 330 may include stainless steel, aluminum, titanium, or combinations thereof. In some implementations, the display stiffener 330 may include a plastic material such as carbon fiber reinforced plastic (CFRP). In some implementations, the display stiffener 330 may have a thickness between about 30 μm and about 300 μm.

An electrically conductive layer 320 may be positioned, located, or otherwise disposed between the ultrasonic sensor stack 305 and the display stack 311. The electrically conductive layer 320 may be, or may include, a metal such as copper. Specifically, the electrically conductive layer 320 may include copper and, more particularly, thick copper tape. In some other instances, the electrically conductive layer 320 may include aluminum tape or thick stainless steel tape. In some implementations, the electrically conductive layer 320 may have a thickness between about 10 μm and about 200 μm or between about 20 μm and about 100 μm. The electrically conductive layer 320 may function as an electrical shielding layer between the ultrasonic sensor stack 305 and the display stack 311. In some examples, the electrical shielding layer may provide an electrical or electromagnetic barrier or electromagnetic interference shield from other electrical components. In addition, the electrical shielding layer may serve a thermal function by providing heat dissipation and improved temperature uniformity at a back area of a display.

The electrically conductive layer 320 may be composed of a high-impedance material. In some implementations, the electrically conductive layer 320 may have an acoustic impedance value greater than about 5.0 MRayls, greater than about 8.0 MRayls, or greater than about 10.0 MRayls. An optional adhesive layer 318 may be disposed between the electrically conductive layer 320 and the display stiffener 330 to attach the electrically conductive layer 320 to the display stack 311. An optional adhesive layer 316 may be disposed between the electrically conductive layer 320 and the transistor layer 302 to attach the electrically conductive layer 320 to the ultrasonic sensor stack 305. In some examples, the adhesive layers 316 and/or 318 may be, or may include, a pressure-sensitive adhesive (PSA). That way, the high-impedance material of the electrically conductive layer 320 may be sandwiched between low-impedance materials.

Generally, as ultrasonic waves travel through a medium, incident signals may be partially transmitted through an adjacent medium and partially reflected backwards. A high level of acoustic impedance mismatch such as a boundary between a high-impedance material and a low-impedance material may cause most of the ultrasonic waves to be reflected back into a given medium. The reflected ultrasonic waves may constructively interfere with consecutively generated ultrasonic waves in the given medium, resulting in enhanced signals that amplify over time. Thus, proper selection of the material, thickness, and density of the various mediums in a stack-up may result in the formation of an acoustic cavity or acoustic resonant cavity that exhibits resonant behavior at a particular frequency. The acoustic resonant cavity may also be referred to as an acoustic resonator, cavity resonator, or resonator. The acoustic resonator may cause a local amplitude maximum in the ultrasonic frequency range. In some examples, an acoustic resonator may be formed between boundaries having high acoustic impedance mismatches.

Referring to the apparatus 300 of FIG. 3, an acoustic resonator 350a may be formed by the display stiffener 330, the electrically conductive layer 320, and the transistor layer 302. The acoustic resonator 350a may optionally include the adhesive layers 316 and/or 318. A high acoustic impedance mismatch may exist at a boundary interface between the display 340 and the display stiffener 330, and a high acoustic impedance mismatch may also exist at a boundary interface between the transistor layer 302 and the piezoelectric layer 301. Although each of the display stiffener 330 (e.g., titanium) and the electrically conductive layer 320 (e.g., copper tape) alone causes low transmission of ultrasonic waves in the frequency range from 1 MHz to 20 MHz, the acoustic resonator 350a comprising the display stiffener 330, the electrically conductive layer 320, and the transistor layer 302 functions to amplify transmission of ultrasonic waves. The acoustic resonator 350a is configured to enhance the ultrasonic waves transmitted by the ultrasonic sensor stack 305 in an ultrasonic frequency range. The particular frequency of the ultrasonic wave being transmitted through the acoustic resonator 350a has a corresponding wavelength (k). To amplify or enhance the ultrasonic waves transmitted by the ultrasonic sensor stack 305, the thickness of the acoustic resonator 350a may correspond to a multiple N of a half wavelength (N*λ/2) associated with a frequency of ultrasonic waves generated by the ultrasonic sensor stack 305 or a multiple N of a quarter wavelength (N*λ/4) associated with a frequency of ultrasonic waves generated by the ultrasonic sensor stack 305, where N is an integer greater than or equal to 1. The acoustic resonator 350a may cause a local amplitude maximum within the ultrasonic frequency range.

Additionally, an acoustic resonator 350b may be formed by the piezoelectric layer 301, the electrode layer 310, and the passivation layer 312. A high acoustic impedance mismatch may exist at a boundary interface between the transistor layer 302 and the piezoelectric layer 301, and a high acoustic impedance mismatch may also exist at a boundary interface between the passivation layer 312 and air. The acoustic resonator 350b is configured to enhance the ultrasonic waves transmitted by the ultrasonic sensor stack 305 in an ultrasonic frequency range. The thickness of the acoustic resonator 350b may correspond to a multiple N of a half wavelength (N*λ/2) associated with a frequency of ultrasonic waves generated by the ultrasonic sensor stack 305 or a multiple N of a quarter wavelength (N*λ/4) associated with a frequency of ultrasonic waves generated by the ultrasonic sensor stack 305, where N is an integer greater than or equal to 1. The acoustic resonator 350b may cause a local amplitude maximum within the ultrasonic frequency range.

In some implementations, the thickness of the acoustic resonator 350b comprising the piezoelectric layer 301, the electrode layer 310, and the passivation layer 312 corresponds to a multiple N of a quarter wavelength (N*λ/4) associated with a frequency of ultrasonic waves generated by the ultrasonic sensor stack 305. In some implementations, the thickness of the acoustic resonator 350b comprising the piezoelectric layer 301, the electrode layer 310, and the passivation layer 312 corresponds to a multiple N of a half wavelength (N*λ/2) associated with a frequency of ultrasonic waves generated by the ultrasonic sensor stack 305. To satisfy the quarter wavelength or half wavelength thickness criterion of the acoustic resonator 350b, the thickness of the electrode layer 310 is typically tuned. The thickness of the electrode layer 310 is selected or tuned according to the frequency of the ultrasonic waves so that the acoustic resonator 350b causes a local amplitude maximum within the ultrasonic frequency range. Put another way, the thickness of the electrode layer 310 is tuned to match the frequency of the ultrasonic waves generated by the ultrasonic sensor stack 305. That way, the effective thickness of the summation of multiple layers in the acoustic resonator 350b can satisfy the N*λ/4 rule or N*λ/2 rule.

The frequency of the ultrasonic waves may correspond to a frequency between about 1 MHz and about 20 MHz. The frequency of the ultrasonic waves may be selected based on a variety of factors. In some instances, a certain frequency may be selected based on a display type of the display, where a foldable display may generally pass frequencies between about 7 MHz and about 8 MHz, and where other display types may generally pass frequencies between about 10 MHz and about 15 MHz. In some instances, a certain frequency may be selected based on types of imaging to be obtained by the ultrasonic sensor stack 305, where fingerprint imaging may be optimized using frequencies of 10 MHz or more, and where sub-epidermal feature imaging may be optimized using frequencies less than 10 MHz. Depending on the frequency of the ultrasonic waves, the thickness of the electrode layer 310 may be tuned accordingly. By way of an example, where the electrode layer 310 is made of a conductive ink such as silver ink, the thickness of the silver ink becomes increasingly larger as the frequency of the ultrasonic waves becomes lower. This is especially the case involving frequency ranges less than about 12 MHz or less than about 10 MHz, such as between about 5 MHz and about 8 MHz or between about 1 MHz and about 5 MHz As discussed above, excessively thick silver ink layers present additional costs in manufacturing and challenges in performance and yield.

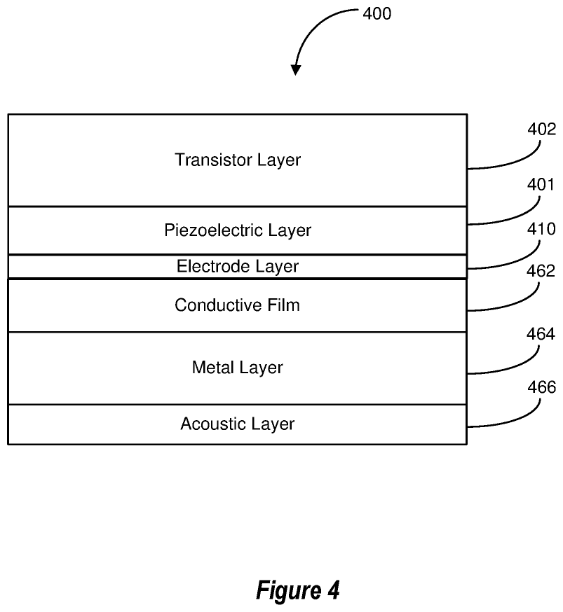

FIG. 4 shows a cross-sectional schematic view of an example apparatus including an ultrasonic sensor stack with a tunable metal layer according to some disclosed implementations. The apparatus includes an ultrasonic sensor stack 400, where the ultrasonic sensor stack 400 is configured to transmit and receive ultrasonic waves. The ultrasonic sensor stack 400 includes a transistor layer 402 having a substrate and an array of sensor pixels. In some implementations, the substrate includes a silicon substrate, a glass substrate, or a plastic substrate. For example, the plastic substrate may include polyimide. The ultrasonic sensor stack 400 further includes a piezoelectric layer 401 coupled to the transistor layer 402. The piezoelectric layer 401 may serve as an ultrasonic transmitter, ultrasonic receiver, or ultrasonic transceiver configured to transmit and receive ultrasonic waves. The piezoelectric layer 401 may include a piezoelectric material such as PVDF or a layer of PVDF-TrFE copolymer. Other piezoelectric materials may be used such as AlN or PZT. The ultrasonic sensor stack 400 further includes an electrode layer 410 coupled to the piezoelectric layer 401. The electrode layer 410 may be a thin metal layer such as a think metal layer of silver ink or silver paste. By way of an example, the thin metal layer may include silver paste having a thickness equal to or less than about 10 μm. In another example, the thin metal layer may include silver ink having a thickness equal to or less than about 2 μm. The silver ink may be without particles and may become pure silver after one or more reduction reactions. The ultrasonic sensor stack 400 further includes a metal layer 464 coupled to the electrode layer 410. In some implementations, the metal layer 464 includes a copper layer. The metal layer 464 has a thickness tuned to match a peak frequency in an ultrasonic frequency range of the ultrasonic waves transmitted by the ultrasonic sensor stack 400. The thickness of the metal layer 464 may be greater than a thickness of the electrode layer 410. In some implementations, the metal layer 464 is coupled to the electrode layer 410 via a conductive film layer 462. The conductive film layer 462 is located between the metal layer 464 and the electrode layer 410, wherein the conductive film layer 462 provides electrical interconnection between the metal layer 464 and the electrode layer 410. In some implementations, the conductive film layer 462 may be a thin film or a paste. In some implementations, the conductive film layer 462 is anisotropic or isotropic. For instance, the conductive film layer 462 includes an anisotropic conductive film (ACF) layer. Particles in the ACF layer provide thickness uniformity to the conductive film layer 462. In some implementations, the ultrasonic sensor stack 400 further includes an acoustic layer 466 coupled to the metal layer 464. The acoustic layer 466 includes a material having an acoustic impedance value that is less than an acoustic impedance value of the metal layer 464. In some implementations, the acoustic layer 466 is tuned to optimize amplification of a signal of the ultrasonic waves. In some implementations, the acoustic layer 466 includes polyimide or polyethylene terephthalate. The acoustic layer 466 and the metal layer 464 may be part of a stack such as a flexible copper clad laminate (FCCL) stack.

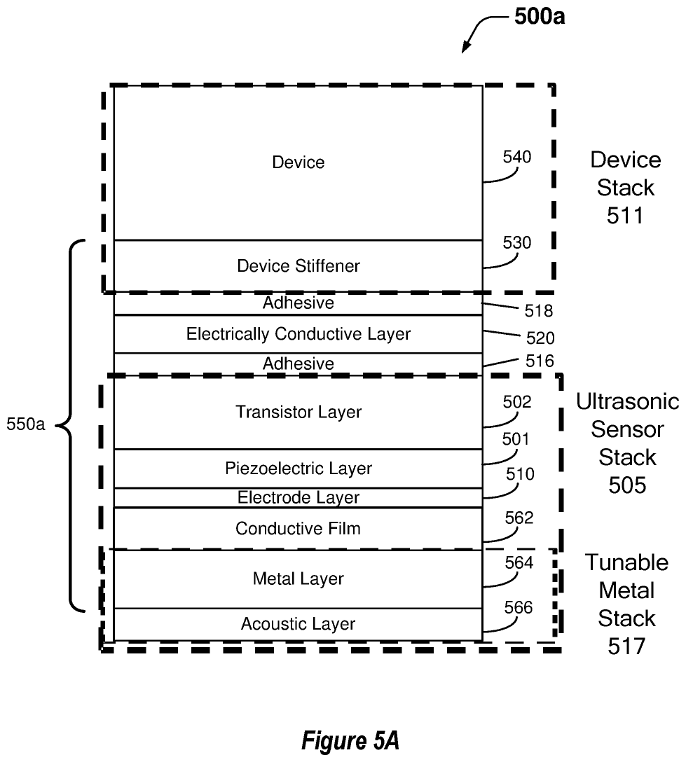

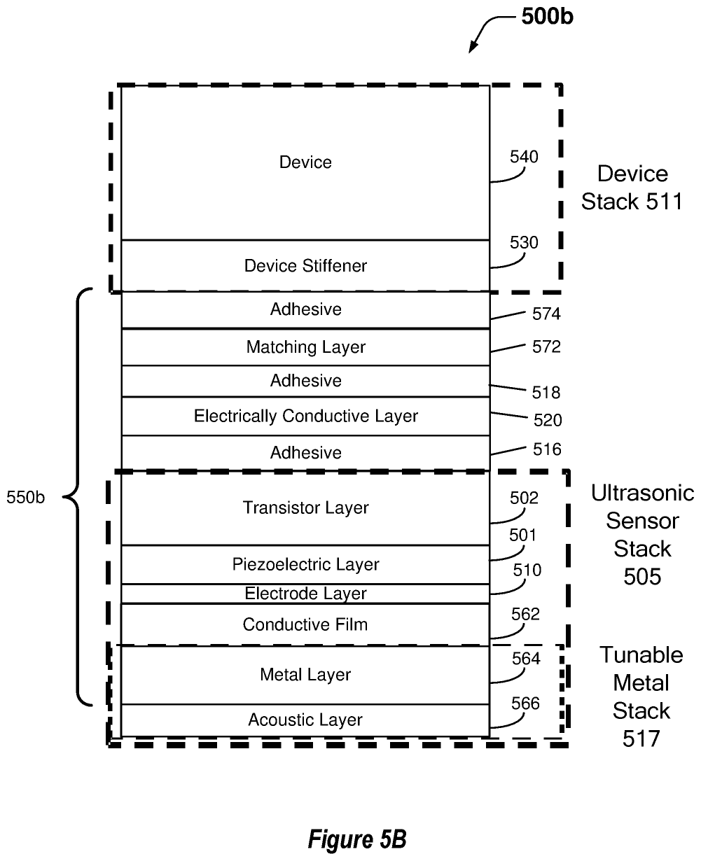

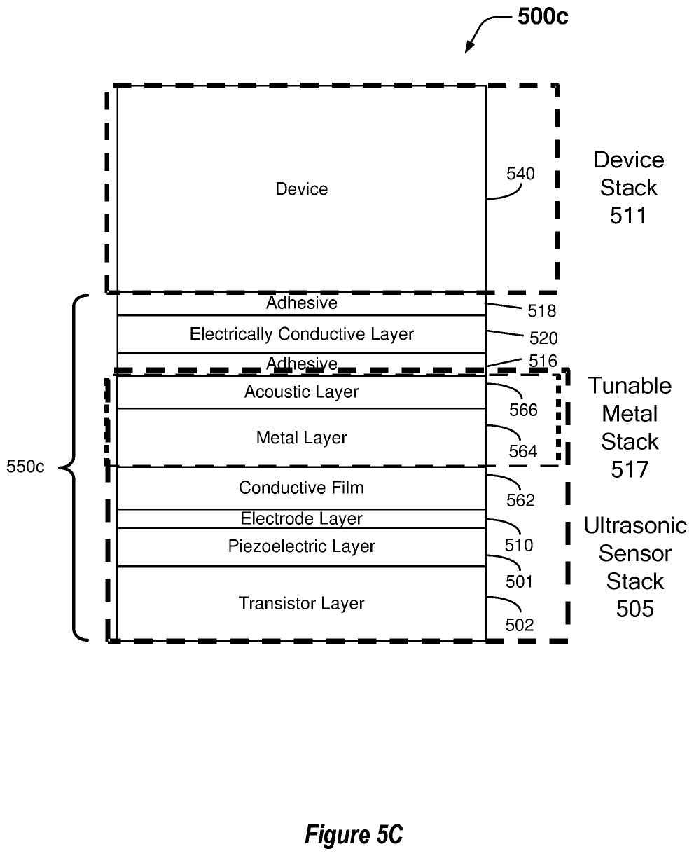

FIG. 5A shows a cross-sectional schematic view of an example apparatus including a device stack, an ultrasonic sensor stack in a “receiver down” orientation and having a thin electrode layer, and a tunable metal stack according to some disclosed implementations. As with other disclosed implementations, the types, number and arrangement of elements shown in FIG. 5A are merely examples. Other implementations may include different types, numbers and/or arrangements of elements. Moreover, the elements shown in FIG. 5A are not drawn to scale.

According to this example, the apparatus 500a includes an ultrasonic sensor stack 505, a device stack 511, and a tunable metal stack 517. The ultrasonic sensor stack 505 may be underlying the device stack 511. The ultrasonic sensor stack 505 may comprise the tunable metal stack 517. Though the tunable metal stack 517 is illustrated as part of the ultrasonic sensor stack 505, it will be understood that the tunable metal stack 517 may be considered separate from the ultrasonic sensor stack 505. As such, the tunable metal stack 517 may be coupled to the ultrasonic sensor stack 505 according to some implementations.

The ultrasonic sensor stack 505 is configured to transmit and receive ultrasonic waves, where the ultrasonic waves propagate and are reflected along an acoustic path. According to this example, the ultrasonic sensor stack 505 includes a transistor layer 502, a piezoelectric layer 501, and an electrode layer 510. The ultrasonic sensor stack 505 further includes the tunable metal stack 517. In this example of the “receiver down” orientation, the transistor layer 502 resides between the piezoelectric layer 501 and the device stack 511. In the “receiver down” orientation, the piezoelectric layer 501 is on a side of the transistor layer 502 facing away from the display 540. The transistor layer 502 is coupled to the piezoelectric layer 501. The transistor layer 502 is disposed over the piezoelectric layer 501 so that the transistor layer 502 is in the acoustic path. The transistor layer 502 may include a transistor substrate such as a TFT substrate and an array of sensor pixels. The transistor layer 502 may be a type of MOSFET made by depositing thin films of an active semiconductor layer as well as a dielectric layer and metallic contacts over a transistor substrate. In some implementations, the transistor substrate may include a semiconducting material such as silicon. In some implementations, the transistor substrate may include a non-conductive material such as glass or plastic. For example, the transistor substrate may include polyimide. In some implementations, the transistor layer 502 may have a thickness that is in the range of 50 μm to 400 μm.

The ultrasonic sensor stack 505 may include one or more piezoelectric materials, where the one or more piezoelectric materials serve as part of an ultrasonic transmitter, ultrasonic receiver, or ultrasonic transceiver configured to transmit and receive ultrasonic waves. In some implementations, the ultrasonic sensor stack 505 further includes a piezoelectric layer 501 that is coupled to the transistor layer 502. Though the piezoelectric layer 501 is illustrated as a single piezoelectric layer, it will be understood that the piezoelectric layer 501 may be a multi-layer piezoelectric structure or an array of such structures. The piezoelectric layer 501 may include a piezoelectric material such as PVDF polymer or a layer of PVDF-TrFE copolymer. Other piezoelectric materials may be used such as AlN or PZT. In some implementations, a thickness of the piezoelectric layer 501 is between about 5 μm and about 30 μm or between about 10 μm and about 20 μm.

The ultrasonic sensor stack 505 further includes an electrode layer 510 coupled to the piezoelectric layer 501. Ultrasonic waves may be generated by providing an electrical signal to the electrode layer 510 coupled to the piezoelectric layer 501. In some implementations, the electrode layer 510 may be, or may include, a metal such as copper, gold, silver, etc. In some implementations, the electrode layer 510 may be, or may include, a conductive film such as silver ink or silver paste. Having a silver ink electrode may be advantageous for many reasons. Fist, silver ink may be easily printed on a large substrate, whereas other metals such as copper require lamination or other methods that are typically more costly and can possibly trap bubbles. Second, silver ink has an acoustic impedance that is more likely to match closely with the piezoelectric layer 501, whereas a metal such as copper is more likely to result in an acoustic impedance mismatch with the piezoelectric layer 501. The electrode layer 510 is a thin metal layer. In some implementations, a thickness of the electrode layer 510 is equal to or less than about 10 μm, equal to or less than about 5 μm, equal to or less than about 3 μm, or equal to or less than about 1 μm. This may be referred to as a “thin” electrode layer. By using a thin metal layer for the electrode layer 510, the electrode layer 510 serves as an acoustically transparent electrode to facilitate transmission of ultrasonic waves therethrough. Silver inks or silver pastes may comprise nonhomogeneous materials and may comprise a plurality of small particles. Silver inks or silver pastes also have rough surfaces. By reducing the thickness of the electrode layer 510 to a negligible value, this improves acoustic transmission of ultrasonic waves, improves image quality, and minimizes image distortions. Furthermore, using a thin metal layer for the electrode layer 510 avoids thickness variations and other manufacturing challenges.

The apparatus 500a further includes a device stack 511. The device stack 511 may include one or more display layers, one or more metal layers, one or more ceramic layers, one or more glass layers, one or more plastic layers, one or more composite layers, or combinations thereof. The ultrasonic sensor stack 505 is underlying the device stack 511, thereby forming an under-display, under-metal, under-ceramic, under-glass, under-plastic, or under-composite sensor. The device stack 511 may be selected from a group consisting of: a display stack, a metal stack, a ceramic stack, a glass stack, a plastic stack, and a composite stack. In some implementations, the device stack 511 is a display stack.

The device stack 511 may include a device stiffener 530 and a device 540. In some implementations, the device 540 includes a display such as a foldable display. The display may include one or more display layers such as one or more layers of an LED or OLED display. Examples of display layers are discussed above with reference to FIG. 2. The device stiffener 530 may be, or may include, a high-impedance material such as a metal. In some examples, the device stiffener 530 may have an acoustic impedance value greater than about 5.0 MRayls, greater than about 8.0 MRayls, or greater than about 10.0 MRayls. In some implementations, the device stiffener 530 may include stainless steel, aluminum, titanium, or combinations thereof. In some implementations, the device stiffener 530 may include a plastic material such as CFRP. In some implementations, the device stiffener 530 may have a thickness between about 30 μm and about 300 μm.

An electrically conductive layer 520 may be positioned, located, or otherwise disposed between the ultrasonic sensor stack 505 and the device stack 511. The electrically conductive layer 520 may be, or may include, a metal such as copper. Specifically, the electrically conductive layer 520 may include copper and, more particularly, thick copper tape. In some other instances, the electrically conductive layer 520 may include aluminum tape or thick stainless steel tape. In some implementations, the electrically conductive layer 520 may have a thickness between about 10 μm and about 200 μm or between about 20 μm and about 100 μm. The electrically conductive layer 520 may function as an electrical shielding layer between the ultrasonic sensor stack 505 and the device stack 511. In some examples, the electrical shielding layer may provide an electrical or electromagnetic interference shield from other electrical components. In addition, the electrical shielding layer may serve a thermal function by providing heat dissipation and improved temperature uniformity at a back area of a device (e.g., display).

The electrically conductive layer 520 may be composed of a high-impedance material. In some implementations, the electrically conductive layer 520 may have an acoustic impedance value greater than about 5.0 MRayls, greater than about 8.0 MRayls, or greater than about 10.0 MRayls. An optional adhesive 518 may be disposed between the electrically conductive layer 520 and the device stiffener 530 to attach the electrically conductive layer 520 to the device stack 511. An optional adhesive 516 may be disposed between the electrically conductive layer 520 and the transistor layer 502 to attach the electrically conductive layer 520 to the ultrasonic sensor stack 505. In some examples, the adhesives 516 and/or 518 may be, or may include, a pressure-sensitive adhesive (PSA). That way, the high-impedance material of the electrically conductive layer 520 may be sandwiched between low-impedance materials.

The apparatus 500a further includes a tunable metal stack 517. The tunable metal stack 517 includes a metal layer 564 and an acoustic layer 566 coupled to the metal layer 564. The metal layer 564 may be thicker than the electrode layer 510. The metal layer 564 may include a metallic material such as aluminum, nickel, stainless steel, copper, or combinations thereof. For example, the metal layer 564 includes copper. The copper may be provided in the tunable metal stack 517 using any suitable manufacturing technique. In some implementations, the copper is roll-annealed. In some implementations, the copper is electroplated. Using copper as the tunable metal layer instead of the electrode layer 510 improves acoustic performance of the ultrasonic sensor stack 505. In particular, copper has smoother surfaces than silver ink to reduce noise, and copper is a more homogeneous material compared to silver ink to improve transmission of ultrasonic waves. As discussed below, a thickness of the metal layer 564 may be selected or tuned according to a peak frequency in an ultrasonic frequency range of the ultrasonic waves generated by the ultrasonic sensor stack 505.

The acoustic layer 566 may serve to electrically insulate and protect the metal layer 564. Accordingly, the acoustic layer 566 may also be referred to as an electrically insulating layer, protective layer, passivation layer, or backing layer. The acoustic layer 566 may be, or may include, an electrically insulating material such as polyimide (PI) or polyethylene terephthalate (PET). In addition, the acoustic layer 566 may serve to improve acoustic performance of the ultrasonic sensor stack 505. Where the metal layer 564 comprises a high-impedance material, the acoustic layer 566 may comprise a low-impedance material. The acoustic layer 566 may have an acoustic impedance value less than an acoustic impedance value of the metal layer 564. The low-impedance material of the acoustic layer 566 may have an acoustic impedance value less than about 10 MRayls or less than about 5 MRayls. The high acoustic impedance mismatch at a boundary interface between the metal layer 564 and the acoustic layer 566 enhances reflections of ultrasonic waves. Moreover, the acoustic layer 566 may have a smooth surface to reduce noise. For instance, an external surface of the acoustic layer 566 may have a roughness value (in terms of RMS) that is equal to or less than about 5 nm. As discussed below, a thickness of the acoustic layer 566 may be selected or tuned to amplify or enhance the ultrasonic waves transmitted by the ultrasonic sensor stack 505.

An electrically conductive material such as a conductive film 562 is positioned, located, or otherwise disposed between the metal layer 564 and the electrode layer 510 of the ultrasonic sensor stack 505. The metal layer 564 is coupled to the electrode layer 510 in the ultrasonic sensor stack 505 via the conductive film 562. The conductive film 562 may be a film or a paste, and the conductive film 562 may be anisotropic or isotropic. The conductive film 562 may be, or may include, anisotropic conductive film (ACF). ACF may include conductive particles dispersed in a polymeric or organic film. In some implementations, the conductive film 562 has a thickness between about 1 μm and about 10 μm or between about 1 μm and about 5 μm. The conductive film 562 provides electrical interconnection between the metal layer 564 and the electrode layer 510. The conductive film 562 may also be an adhesive that bonds the metal layer 564 to the electrode layer 510. The combination of the electrode layer 510, the conductive film 562, and the metal layer 564 provides improved electrical conductivity compared to the electrode layer 510 alone. Where the electrode layer 510 has a thin metal layer, the electrical conductivity of the electrode layer 510 is moderately low. However, the addition of the conductive film 562 and the metal layer 564 increases the electrical conductivity.

In some implementations, the metal layer 564 and the acoustic layer 566 of the tunable metal stack 517 may collectively form a flexible copper clad laminate (FCCL) stack. FCCL comprises one or more layers of copper foil and polyimide. Single-sided FCCL comprises copper foil on one side of polyimide. Double-sided FCCL comprises copper foil on both sides of polyimide. Adhesive FCCL includes adhesive material to bond the copper foil to the polyimide. Adhesive-less FCCL omits adhesive material in bonding the copper foil to the polyimide. FCCL is often used as a component in flexible printed circuits (FPCs). FCCL is commercially available, which can reduce the cost and simplify the manufacturing process for incorporating the metal layer 564 and the acoustic layer 566 into an ultrasonic sensor stack 505. Various sizes of FCCL can be obtained readily so that a desired thickness of the copper foil can be incorporated into the ultrasonic sensor stack 505. In view of the wide availability of FCCL of various sizes, a thickness of the metal layer 564 can be easily tuned according to a frequency of the ultrasonic waves of the ultrasonic sensor stack 505. Additionally or alternatively, a desired thickness of the polyimide can be incorporated in the ultrasonic sensor stack 505. Again, given the wide availability of FCCL of various sizes, a thickness of the acoustic layer 566 can be easily adjusted and optimized for acoustic performance.

Referring to the apparatus 500a of FIG. 5A, an acoustic resonator 550a may be formed by the device stiffener 530, the electrically conductive layer 520, the transistor layer 502, the piezoelectric layer 501, the electrode layer 510, the conductive film 562, and the metal layer 564. The acoustic resonator 550a may optionally include the adhesives 516 and/or 518. A high acoustic impedance mismatch may exist at a boundary interface between the device 540 and the device stiffener 530, and a high acoustic impedance mismatch may also exist at a boundary interface between the acoustic layer 566 and the metal layer 564. The acoustic resonator 550a is configured to enhance the ultrasonic waves transmitted by the ultrasonic sensor stack 505 in an ultrasonic frequency range. The particular frequency of the ultrasonic wave being transmitted through the acoustic resonator 550a has a corresponding wavelength (k). To amplify or enhance the ultrasonic waves transmitted by the ultrasonic sensor stack 505, the thickness of the acoustic resonator 550a may correspond to a multiple N of a half wavelength (N*λ/2) of a peak frequency in an ultrasonic frequency range of the ultrasonic waves generated by the ultrasonic sensor stack 505 or a multiple N of a quarter wavelength (N*λ/4) of a peak frequency in an ultrasonic frequency range of the ultrasonic waves generated by the ultrasonic sensor stack 505, where N is an integer greater than or equal to 1. For example, the thickness of the acoustic resonator 550a corresponds to a multiple N of a half wavelength (N*λ/2) of a peak frequency in an ultrasonic frequency range of the ultrasonic waves generated by the ultrasonic sensor stack 505. The acoustic resonator 550a may cause a local amplitude maximum within the ultrasonic frequency range.

To satisfy the half wavelength thickness criterion of the acoustic resonator 550a, the thickness of the metal layer 564 is tuned. The thickness of the metal layer 564 is selected or tuned according to the frequency (e.g., peak frequency) of the ultrasonic waves so that the acoustic resonator 550a causes a local amplitude maximum within the ultrasonic frequency range. In other words, the thickness of the metal layer 564 is tuned to match the frequency of the ultrasonic waves generated by the ultrasonic sensor stack 505. As a result, the effective thickness of the acoustic resonator 550a comprising the device stiffener 530, the electrically conductive layer 520, the transistor layer 502, the piezoelectric layer 501, the electrode layer 510, the conductive film 562, and the metal layer 564 can satisfy the N*λ/2 rule.

Depending on the frequency of the ultrasonic waves generated by the ultrasonic sensor stack 505, the thickness of the metal layer 564 may be tuned accordingly rather than the electrode layer 510. The thickness of the electrode layer 510 may be negligible, where the thickness of the electrode layer 510 may be fixed at a value equal to or less than about 10 μm, equal to or less than about 5 μm, equal to or less than about 3 μm, or equal to or less than about 1 μm. The peak frequency of the ultrasonic waves generated by the ultrasonic sensor stack may be between about 2 MHz and about 20 MHz. The thickness of the metal layer 564 such as a copper layer may be between about 1 μm and about 120 μm. In one example, the peak frequency of the ultrasonic waves generated by the ultrasonic sensor stack 505 is between about 10 MHz and about 18 MHz. In such instances, the metal layer 564 such as a copper layer has a thickness in a range of about 2 μm to about 18 μm. In another example, the peak frequency of the ultrasonic waves generated by the ultrasonic sensor stack 505 is between about 3 MHz and about 10 MHz. In such instances, the metal layer 564 such as a copper layer has a thickness in a range of about 20 μm to about 80 μm. However, it will be understood that the thickness of the metal layer 564 such as a copper layer is not necessarily a direct correlation with resonance, as multiple layers in the ultrasonic sensor stack 505 and below the ultrasonic sensor stack 505 may affect the resonance of the acoustic resonator 550a.

The thickness of the acoustic layer 566 may also be tuned to optimize acoustic performance of the ultrasonic sensor stack 505. In some implementations, the thickness of the acoustic layer 566 is between about 1 μm and about 50 μm, between about 2 μm and about 30 μm, or between about 3 μm and about 20 μm.

FIG. 5B shows a cross-sectional schematic view of an example apparatus including a device stack, an ultrasonic sensor stack in a “receiver down” orientation and having a thin electrode layer, a matching layer between the device stack and the ultrasonic sensor stack, and a tunable metal stack according to some disclosed implementations. As with other disclosed implementations, the types, number and arrangement of elements shown in FIG. 5B are merely examples. Other implementations may include different types, numbers and/or arrangements of elements. Moreover, the elements shown in FIG. 5B are not drawn to scale.

According to this example, the apparatus 500b includes an ultrasonic sensor stack 505, a device stack 511, a tunable metal stack 517, and a matching layer 572 between the device stack 511 and the ultrasonic sensor stack 505. In fact, various aspects of the apparatus 500b of FIG. 5B are identical to the apparatus 500a of FIG. 5A except that the apparatus 500b of FIG. 5B includes a matching layer 572 and adhesive 574. Accordingly, aspects of the device stack 511, the ultrasonic sensor stack 505, the tunable metal stack 517, the electrically conductive layer 520, the adhesive 518, the adhesive 516, and the conductive film 562 are described above with reference to FIG. 5A. Details regarding these stacks, layers, and/or films of FIG. 5B are not repeated.

The matching layer 572 is positioned, located, or otherwise disposed between the electrically conductive layer 520 and the device stiffener 530 of the device stack 511. An optional adhesive 518 may bond the electrically conductive layer 520 to the matching layer 572. An optional adhesive 574 may be positioned, located, or otherwise disposed between the matching layer 572 and the device stiffener 530. The adhesive 574 may bond the matching layer 572 to the device stiffener 530. The matching layer 572 may increase acoustic transmission of ultrasonic waves in the apparatus 500b, thereby improving the performance (e.g., resolution) of the ultrasonic sensor stack 505 for imaging.

The matching layer 572 may have an acoustic impedance value between the acoustic impedance values of the device stiffener 530 and the adhesive 518. The adhesive 518 is positioned between the device stiffener 530 and the ultrasonic sensor stack 505. The matching layer 572 may have an acoustic impedance value greater than the adhesive 518 but less than the device stiffener 530. Layers or materials with high acoustic impedance values may be referred to herein as “hard” materials, and layers or materials with low acoustic impedance values may be referred to herein as “soft” materials. The adhesive 518 is typically a “soft” material having an acoustic impedance value less than about 8.0 MRayls, and the device stiffener 530 is typically a “hard” material having an acoustic impedance value greater than 10.0 MRayls or greater than 20.0 MRayls. Without the matching layer 572, an acoustic impedance mismatch occurs at a boundary interface between the adhesive 518 and the device stiffener 530. The higher the acoustic impedance mismatch, the greater the acoustic reflections in the stack-up. However, one or more acoustic impedance matching layers such as the matching layer 572 may be included in the stack-up between the device stiffener 530 and the adhesive 518 to minimize acoustic reflections. This increases the acoustic transmission of ultrasonic waves from the adhesive 518 to the device stiffener 530.

In some implementations, the matching layer 572 may have an acoustic impedance value between about 3.0 MRayls and about 20.0 MRayls or between about 5.0 MRayls and about 10.0 MRayls. For example, the matching layer 572 may include an epoxy doped with particles that change the density of the matching layer 572. Such particles may include but are not limited to aluminum oxide particles, tungsten particles, or titanium oxide particles. The density of the matching layer 572 changes depending on the particle loading. If the density of the matching layer 572 is changed, then the acoustic impedance value will also change according to the change in density, assuming that the acoustic velocity remains constant. In alternative implementations, the matching layer 572 may include silicone rubber doped with metal or with ceramic powder.

The matching layer 572 may have a thickness greater than a thickness of the adhesive 518. In some implementations, a thickness of the matching layer 572 is between about 10 μm and about 100 μm or between about 20 μm and about 80 μm.

The adhesive 574 may include an adhesive material such as a pressure-sensitive adhesive or epoxy. For example, the adhesive 574 may include double-sided tape. The adhesive 574 may have a thickness less than a thickness of the matching layer 572. In some implementations, a thickness of the adhesive 574 is between about 1 μm and about 10 μm or between about 2 μm and about 8 μm. The thickness of the adhesive 574 is relatively low so as to be acoustically transparent or substantially acoustically transparent to ultrasonic waves.

Referring to the apparatus 500b of FIG. 5B, an acoustic resonator 550b may be formed by the adhesive 574, the matching layer 572, the adhesive 518, the electrically conductive layer 520, the adhesive 516, the transistor layer 502, the piezoelectric layer 501, the electrode layer 510, the conductive film 562, and the metal layer 564. A high acoustic impedance mismatch may exist at a boundary interface between the device stiffener 530 and the adhesive 574, and a high acoustic impedance mismatch may also exist at a boundary interface between the acoustic layer 566 and the metal layer 564. The acoustic resonator 550b is configured to enhance the ultrasonic waves transmitted by the ultrasonic sensor stack 505 in an ultrasonic frequency range. To amplify or enhance the ultrasonic waves transmitted by the ultrasonic sensor stack 505, the thickness of the acoustic resonator 550b may correspond to a multiple N of a half wavelength (N*λ/2) of a peak frequency in an ultrasonic frequency range of the ultrasonic waves generated by the ultrasonic sensor stack 505 or a multiple N of a quarter wavelength (N*λ/4) of a peak frequency in an ultrasonic frequency range of the ultrasonic waves generated by the ultrasonic sensor stack 505, where N is an integer greater than or equal to 1. For example, the thickness of the acoustic resonator 550b corresponds to a multiple N of a half wavelength (N*λ/2) of a peak frequency in an ultrasonic frequency range of the ultrasonic waves generated by the ultrasonic sensor stack 505. The acoustic resonator 550b may cause a local amplitude maximum within the ultrasonic frequency range. The thickness of the metal layer 564 is selected or tuned according to the frequency (e.g., peak frequency) of the ultrasonic waves so that the acoustic resonator 550b causes a local amplitude maximum within the ultrasonic frequency range. As such, the thickness of the metal layer 564 is tuned to match the frequency of the ultrasonic waves generated by the ultrasonic sensor stack 505.

FIG. 5C shows a cross-sectional schematic view of an example apparatus including a device stack, an ultrasonic sensor stack in a “receiver up” orientation and having a thin electrode layer, and a tunable metal stack according to some disclosed implementations. As with other disclosed implementations, the types, number and arrangement of elements shown in FIG. 5C are merely examples. Other implementations may include different types, numbers and/or arrangements of elements. Moreover, the elements shown in FIG. 5C are not drawn to scale.

According to this example, the apparatus 500c includes an ultrasonic sensor stack 505, a device stack 511, and a tunable metal stack 517. In fact, various aspects of the apparatus 500c of FIG. 5C are identical to the apparatus 500a of FIG. 5A except that the apparatus 500c of FIG. 5C arranges the piezoelectric layer 501 on a side of the transistor layer 502 facing towards the device 540 (instead of away from the device 540) where the electrode layer 510, the conductive film 562, the metal layer 564, the acoustic layer 566, and the electrically conductive layer 520 are in the acoustic path. In a “receiver up” orientation, the electrode layer 510 is in the acoustic path while the transistor layer 502 is not in the acoustic path. The tunable metal stack 517 is between the electrode layer 510 and the device stack 511. In a “receiver down” orientation, the transistor layer 502 is in the acoustic path but the electrode layer 510 is not in the acoustic path. The electrode layer 510 is between the tunable metal stack 517 and the device stack 511. Aspects of the device stack 511, the ultrasonic sensor stack 505, the tunable metal stack 517, the electrically conductive layer 520, the adhesive 518, the adhesive 516, and the conductive film 562 are described above with reference to FIG. 5A. Details regarding these stacks, layers, and/or films of FIG. 5C are not repeated.

In the apparatus 500c of FIG. 5C, the ultrasonic sensor stack 505 includes the tunable metal stack 517. However, as discussed above, it will be understood that the tunable metal stack 517 may be considered separate from the ultrasonic sensor stack 505 rather than as part of the ultrasonic sensor stack 505. The ultrasonic sensor stack 505 includes the transistor layer 502, the piezoelectric layer 501 coupled to and overlying the transistor layer 502, and the electrode layer 510 coupled to and overlying the piezoelectric layer 501. The conductive film 562 is disposed between the metal layer 564 and the electrode layer 510. The metal layer 564 is coupled to and overlying the electrode layer 510, where the metal layer 564 is coupled to the electrode layer 510 via the conductive film 562. The acoustic layer 566 is coupled to and overlying the metal layer 564. The electrically conductive layer 520 is coupled to and overlying the acoustic layer 566. In some implementations, the adhesive 516 bonds the electrically conductive layer 520 to the acoustic layer 566. In some implementations, the adhesive 518 bonds the display 540 to the electrically conductive layer 520. In some other implementations, the adhesives 516 and/or 518 are omitted so that the electrically conductive layer 520 is sandwiched between the acoustic layer 566 and the display 540, and the electrically conductive layer 520 directly attaches to the acoustic layer 566 and the display 540. The electrically conductive layer 520 may replace a device stiffener (e.g., device stiffener 530) that is typically associated with the device stack 511. The electrically conductive layer 520 may, in some implementations, function to increase device stiffness to the device stack 511.

Referring to the apparatus 500c of FIG. 5C, an acoustic resonator 550c may be formed by the electrically conductive layer 520, the acoustic layer 566, the metal layer 564, the conductive film 562, the electrode layer 510, the piezoelectric layer 501, and the transistor layer 502. A high acoustic impedance mismatch may exist at a boundary interface between the device 540 and the electrically conductive layer 520, and a high acoustic impedance mismatch may also exist at a boundary interface between the transistor layer 502 and air. The acoustic resonator 550c is configured to enhance the ultrasonic waves transmitted by the ultrasonic sensor stack 505 in an ultrasonic frequency range. To amplify or enhance the ultrasonic waves transmitted by the ultrasonic sensor stack 505, the thickness of the acoustic resonator 550c may correspond to a multiple N of a half wavelength (N*λ/2) of a peak frequency in an ultrasonic frequency range of the ultrasonic waves generated by the ultrasonic sensor stack 505 or a multiple N of a quarter wavelength (N*λ/4) of a peak frequency in an ultrasonic frequency range of the ultrasonic waves generated by the ultrasonic sensor stack 505, where N is an integer greater than or equal to 1. For example, the thickness of the acoustic resonator 550c corresponds to a multiple N of a half wavelength (N*λ/2) of a peak frequency of an ultrasonic frequency range of the ultrasonic waves generated by the ultrasonic sensor stack 505. The acoustic resonator 550c may cause a local amplitude maximum within the ultrasonic frequency range. The thickness of the metal layer 564 is selected or tuned according to the frequency (e.g., peak frequency) of the ultrasonic waves so that the acoustic resonator 550c causes a local amplitude maximum within the ultrasonic frequency range. Accordingly, the thickness of the metal layer 564 is tuned to match the frequency of the ultrasonic waves generated by the ultrasonic sensor stack 505.

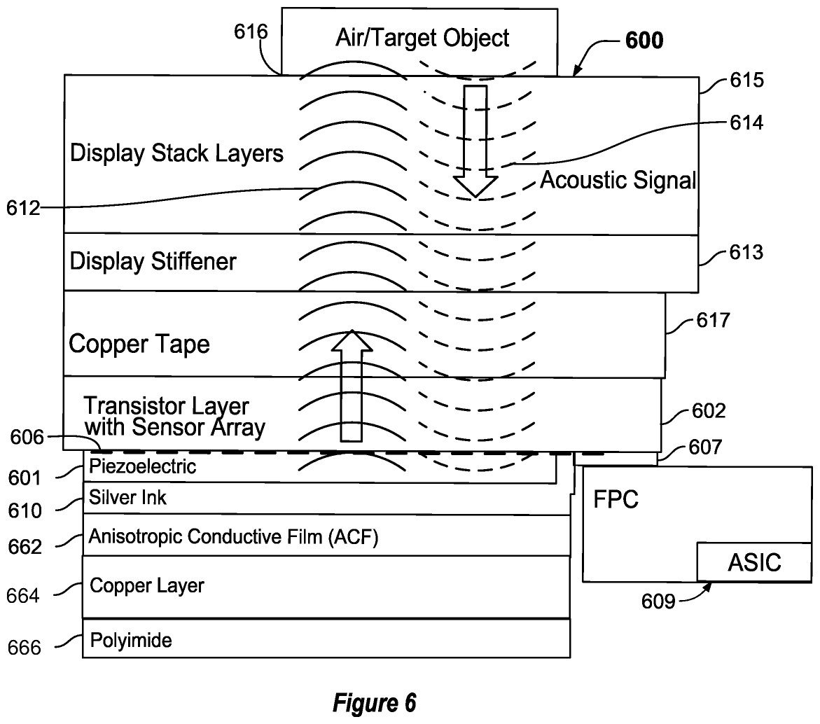

FIG. 6 shows a cross-sectional schematic view of an example apparatus including display stack layers, and an under-display ultrasonic sensor system with a silver ink electrode layer and a tunable copper layer according to some disclosed implementations. As with other disclosed implementations, the types, number and arrangement of elements, as well as the dimensions of elements, are merely examples. According to this example, the apparatus 600 is configured to perform at least some of the methods disclosed herein. According to this implementation, an ultrasonic sensor system includes a transistor layer 602, a piezoelectric layer 601, a silver ink electrode layer 610, an ACF layer 662, a tunable copper layer 664, and a polyimide layer 666. The silver ink electrode layer 610 is on one side of the piezoelectric layer 601 and an array of sensor pixels 606 of the transistor layer 602 is on a second and opposing side of the piezoelectric layer 601. The piezoelectric layer 601 may function as an ultrasonic transceiver. The piezoelectric layer 601 may include one or more piezoelectric polymers. Examples of piezoelectric polymers include but are not limited to PVDF polymer and PVDF-TrFE copolymer.

According to this example, the silver ink electrode layer 610 resides between the tunable copper layer 664 and the piezoelectric layer 601 (i.e., ultrasonic transceiver). The tunable copper layer 664 may be electrically connected and bonded to the silver ink electrode layer 610 via the ACF layer 662. The tunable copper layer 664 has a thickness greater than a thickness of the silver ink electrode layer 610.

In this example, the transistor layer 602 includes a transistor substrate such as a TFT substrate and circuitry for the array of sensor pixels 606. The transistor layer 602 may be a type of MOSFET made by depositing thin films of an active semiconductor layer as well as a dielectric layer and metallic contacts over a transistor substrate. In some examples, the transistor substrate may include a non-conductive material such as glass or plastic. For example, the transistor substrate may include a plastic such as polyimide.

In some implementations, a copper tape 617 is disposed between the display stiffener 613 and the transistor layer 602 of the ultrasonic sensor system.

In this example, the apparatus 600 includes display such as a foldable display. The display may include display stack layers 615 and a display stiffener 613. In some instances, one or more layers of stiffeners may be located between the display stack layers 615 and the copper tape 617 in addition to the display stiffener 613. The display stiffener 613 and any other stiffener(s) typically have a high modulus of elasticity and high acoustic impedance. In some implementations, the display stack layers 615 may form one or more display stack resonators. In some instances, the one or more display stack resonators may be, or may include, the resonators 250a, 250b and/or 250c that are described above with reference to FIG. 2.

According to some implementations, the transistor layer 602, the array of sensor pixels 606, the silver ink electrode layer 610, and the tunable copper layer 664 are electrically coupled to at least a portion of the control system 609 and one side of the piezoelectric layer 601 via a portion of an interface system 607, which includes electrically conducting material and a flexible printed circuit (FPC) in this instance.

In this example, the apparatus 600 is configured to perform at least some of the methods disclosed herein. In this example, the control system 609 is configured to control the ultrasonic sensor system to transmit one or more ultrasonic waves 612. The one or more ultrasonic waves may have a peak frequency between about 1 MHz and about 20 MHz. According to this example, the ultrasonic waves 612 are transmitted through the transistor layer 602, the copper tape 617, the display stiffener 613, and the display stack layers 615. According to this example, reflections 614 of the ultrasonic waves 612 are caused by acoustic impedance contrast at (or near) an interface 616 between the outer surface of the cover and whatever is in contact with the outer surface, which may be air or the surface of a target object, such as the ridges and valleys of a fingerprint, etc. (As used herein, the term “finger” may refer to any digit, including a thumb. Accordingly, a thumbprint will be considered a type of “fingerprint.”).

According to some examples, reflections 614 of the ultrasonic wave(s) 612 may be detected by the array of sensor pixels 606. Corresponding ultrasonic signals may be provided to the control system 609. In some such implementations, ultrasonic signals that are used by the control system 609 for fingerprint-based authentication may be based on reflections 614 from a cover/finger interface that are detected by the array of sensor pixels 606. In some implementations, reflections 614 corresponding to a cover/air interface may be detected by the silver ink electrode layer 610 and corresponding background ultrasonic signals may be provided to the control system 609.

The silver ink electrode layer 610 may be relatively thin, where a thickness of the silver ink electrode layer 610 is equal to or less than about 10 μm, equal to or less than about 5 μm, equal to or less than about 3 μm, or equal to or less than about 1 μm. The thickness of the silver ink electrode layer 610 is less than a thickness of the tunable copper layer 664. The thickness of the silver ink electrode layer 610 enables the silver ink electrode layer 610 to be substantially acoustically transparent to transmission of ultrasonic waves. It will be understood that the silver ink electrode layer 610 may comprise a pure silver ink or silver paste. Silver paste comprises particles of silver in an epoxy, and a pure silver ink comprises pure silver without particles of silver in an epoxy.

The tunable copper layer 664 has a thickness that matches a peak frequency of the ultrasonic waves generated by the ultrasonic sensor system. The peak frequency may be based on the device application of the apparatus 600. In one example, the apparatus 600 may include an OLED display that operates at a frequency between about 10 MHz and about 12 MHz. Or, the apparatus 600 may include a foldable display that operates at a frequency between about 5 MHz and about 8 MHz. Or, the apparatus 600 may include an ultralow frequency application that operates at a frequency between about 3 MHz and about 5 MHz. Accordingly, the thickness of the tunable copper layer 664 may be adjusted, tuned, or otherwise selected to match the frequency of the device application of the apparatus 600. The thickness of the silver ink electrode layer 610 may remain fixed. In some implementations, the thickness of the tunable copper layer 664 is between about 1 μm and about 120 μm, between about 2 μm and about 100 μm, or between about 3 μm and about 80 μm. For instance, at frequencies between about 10 MHz and about 18 MHz, the thickness of the tunable copper layer 664 is between about 2 μm and about 18 μm, and at frequencies between about 3 MHz and about 10 MHz, the thickness of the tunable copper layer 664 is between about 20 μm and about 80 μm.

The polyimide layer 666 is coupled to the tunable copper layer 664. A thickness of the polyimide layer 666 may be configured to optimize acoustic performance of the ultrasonic sensor system. Specifically, the thickness of the polyimide layer 666 is tuned to optimize amplification of a signal of the ultrasonic waves. In some implementations, a thickness of the polyimide layer 666 is between about 1 μm and about 50 μm, between about 2 μm and about 30 μm, or between about 3 μm and about 20 μm. The polyimide layer 666 and the tunable metal layer 664 may collectively form an FCCL stack. Single-sided FCCL stacks or double-sided FCCL stacks may be provided in various sizes. This reduces cost and facilitates ease of implementation in the ultrasonic sensor system for tuning a thickness of the tunable copper layer 664 and/or a thickness of the polyimide layer 666.

In some implementations, an acoustic resonator is bounded by the tunable copper layer 664 and the display stiffener 613. According to this example, the acoustic resonator includes the tunable copper layer 664, the ACF layer 662, the silver ink electrode layer 610, the piezoelectric layer 601, the transistor layer 602, the copper tape 617, and the display stiffener 613. The thickness of the acoustic resonator may correspond to a multiple N of a half wavelength (N*λ/2) at a peak frequency of an ultrasonic frequency range of ultrasonic waves transmitted by the ultrasonic sensor system, where N is an integer greater than or equal to 1. In some such implementations, the acoustic resonator may cause a local amplitude maximum within the ultrasonic frequency range.

The acoustic resonator may be configured to enhance ultrasonic waves transmitted by the ultrasonic sensor system in at least one ultrasonic frequency range. The thickness of the tunable copper layer 664 may be adjusted or tuned in order for the thickness of the acoustic resonator to correspond to a multiple N of a half wavelength, thereby matching the peak frequency of the ultrasonic waves transmitted by the ultrasonic sensor system.

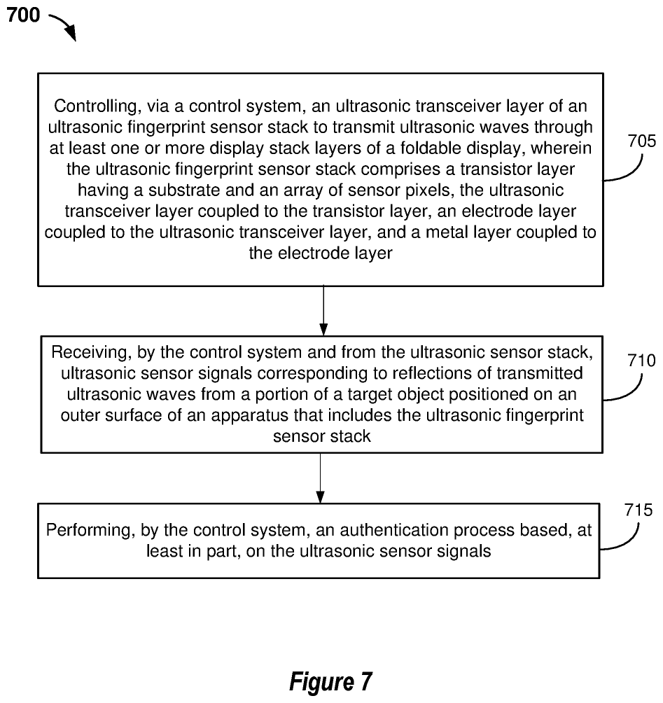

FIG. 7 shows a flow diagram of an example method of operating an apparatus according to some disclosed implementations. The blocks of FIG. 7 may, for example, be performed by the apparatus 100 of FIG. 1 (e.g., by the control system 106 and the ultrasonic sensor stack 105), or by any one of the apparatuses 400, 500a, 500b, 500c, and 600 described in any one of FIGS. 4, 5A, 5B, 5C, and 6. As with other methods disclosed herein, the method outlined in FIG. 7 may include more or fewer blocks than indicated. Moreover, the blocks of methods disclosed herein are not necessarily performed in the order indicated. In some instances, one or more blocks may be performed concurrently.

In this example, block 705 of a process 700 involves controlling, via a control system (e.g., via the control system 106) an ultrasonic transceiver layer of an ultrasonic fingerprint sensor stack (e.g., the ultrasonic transceiver layer 101) to transmit ultrasonic waves (e.g., the ultrasonic waves 612 shown in FIG. 6) through at least one or more device stack layers (e.g., the display stack layers 615 shown in FIG. 6) of a foldable display (e.g., the foldable display stack 111). The ultrasonic fingerprint sensor stack includes a transistor layer (e.g., transistor layer 402) having a substrate and an array of sensor pixels. The ultrasonic fingerprint sensor stack further includes the ultrasonic transceiver layer coupled to the transistor layer and an electrode layer (e.g., electrode layer 410) coupled to the ultrasonic transceiver layer. The ultrasonic transceiver layer may include a piezoelectric layer (e.g., piezoelectric layer 401). In some implementations, the electrode layer has a thickness less than about 10 μm. The ultrasonic fingerprint sensor stack further includes a metal layer (e.g., metal layer 464) coupled to the electrode layer.

In some implementations, the metal layer has a thickness tuned to match a frequency corresponding to a peak frequency in an ultrasonic frequency range of the ultrasonic waves transmitted by the ultrasonic fingerprint sensor stack. In some implementations, the metal layer has a thickness between about 1 μm and about 120 μm, between about 2 μm and about 100 μm, or between about 3 μm and about 80 μm. In some implementations, the metal layer includes a metallic material such as aluminum, nickel, stainless steel, copper, or combinations thereof. For example, the metal layer includes copper. The copper may be part of an FCCL stack.

In some implementations, the metal layer is coupled to the electrode layer via a conductive film such as ACF. In some implementations, an acoustic layer such as polyimide or polyethylene terephthalate is coupled to the metal layer. The metal layer has a high acoustic impedance (e.g., greater than about 10.0 MRayls) and the acoustic layer has a low acoustic impedance (e.g., less than about 10.0 MRayls), thereby forming a large acoustic impedance mismatch at the interface that increases reflections of ultrasonic waves. An acoustic resonator may be bounded by the metal layer and a device stiffener (e.g., device stiffener 530) of the foldable display. A thickness of the acoustic resonator corresponds to a multiple N of a half wavelength (N*λ/2) at the peak frequency of the ultrasonic frequency range of the ultrasonic waves transmitted by the ultrasonic fingerprint sensor stack, where N is an integer greater than or equal to 1.

A thickness of the acoustic layer may be optimized for acoustic performance of the ultrasonic fingerprint sensor stack. In some implementations, the thickness of the acoustic layer is between about 1 μm and about 50 μm, between about 2 μm and about 30 μm, or between about 3 μm and about 20 μm.

The electrode layer may include a conductive layer such as silver ink or silver paste. The electrode layer is sufficiently thin to be acoustically transparent or substantially acoustically transparent to ultrasonic waves. The thickness of the metal layer is greater than the thickness of the electrode layer.

According to this implementation, block 710 of the process 700 involves receiving, by the control system and from the ultrasonic fingerprint sensor stack, ultrasonic sensor signals corresponding to reflections of transmitted ultrasonic waves from a portion of a target object positioned on an outer surface of the apparatus that includes the ultrasonic fingerprint sensor stack. According to some examples, the ultrasonic sensor signals may correspond to reflections from an interior of the portion of the target object. If the target object is a finger, the first signals may correspond to reflections of the first ultrasonic wave(s) from a subsurface of the finger, e.g., of reflections from one or more sub-epidermal features. Alternatively or additionally, the ultrasonic sensor signals may correspond to reflections of the transmitted ultrasonic waves from a surface of the portion of the target object. If the target object is a finger, the ultrasonic sensor signals may correspond to reflections of the second ultrasonic wave(s) from a surface of the finger, e.g., from ridges and valleys of a fingerprint.

According to this implementation, block 715 of the process 700 involves performing, by the control system, an authentication process that is based, at least in part, on the ultrasonic sensor signals. In some implementations, the process 700 may involve controlling access to the apparatus, or to another device, based at least in part on the authentication process.

According to some implementations, block 715 may involve obtaining fingerprint data based on portions of the ultrasonic sensor signals received within a time interval corresponding with fingerprints. The time interval may, for example, be measured relative to a time at which the ultrasonic waves were transmitted. Obtaining the fingerprint data may, for example, involve extracting target object features from the ultrasonic sensor signals. The target object features may, for example, comprise fingerprint features. According to some examples, the fingerprint features may include fingerprint minutiae, keypoints and/or sweat pores. In some examples, the fingerprint features may include ridge ending information, ridge bifurcation information, short ridge information, ridge flow information, island information, spur information, delta information, core information, etc.

In some examples, block 715 may involve comparing the fingerprint features with fingerprint features of an authorized user. The fingerprint features of the authorized user may, for example, have been received during a previous enrollment process.

In some implementations, block 715 may involve extracting sub-epidermal features from the ultrasonic sensor signals. Sub-epidermal features of the authorized user may, for example, have been received during a previous enrollment process. According to some implementations, the authentication process may involve comparing sub-epidermal features extracted from the ultrasonic sensor signals with sub-epidermal features of the authorized user.

In some such implementations, the sub-epidermal features may include sub-epidermal layer information corresponding to reflections of the ultrasonic waves received from the portion of the target object within a time interval corresponding with a sub-epidermal region. The sub-epidermal features may, for example, include dermis layer information corresponding to reflections of the second ultrasonic wave received from the portion of the target object. The dermis layer information may have been obtained within a time interval corresponding with a dermis layer. The authentication process may be based, at least in part, on the dermis layer information. Alternatively, or additionally, the sub-epidermal features may include information regarding other sub-epidermal layers, such as the papillary layer, the reticular layer, the subcutis, etc., any blood vessels, lymph vessels, sweat glands, hair follicles, hair papilla, fat lobules, etc., that may be present within such tissue layers, muscle tissue, bone material, etc.

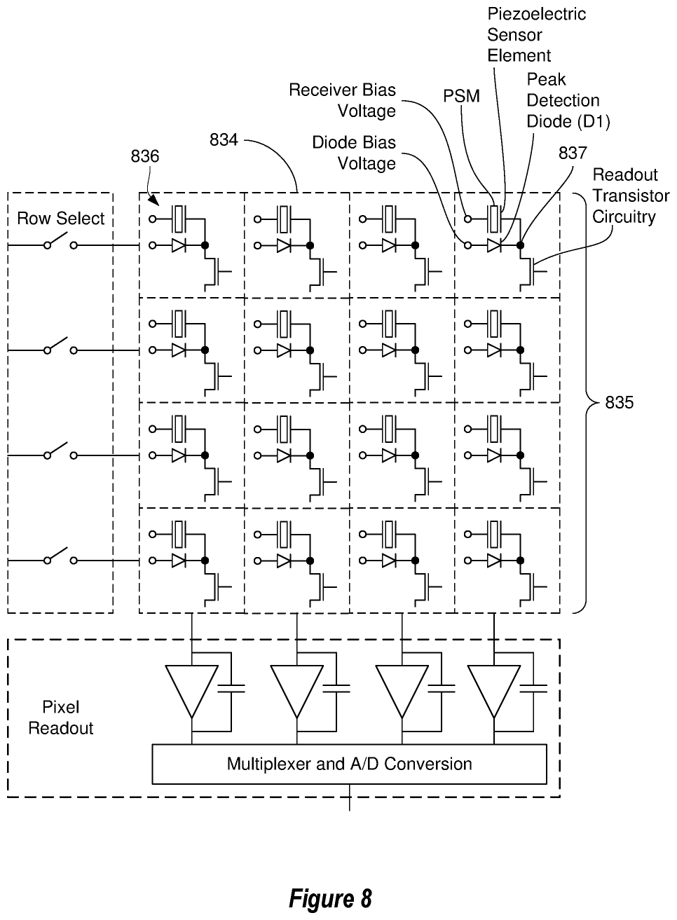

FIG. 8 representationally depicts aspects of a 4×4 pixel array of sensor pixels for an ultrasonic sensor system. Each pixel 834 may be, for example, associated with a local region of piezoelectric sensor material (PSM), a peak detection diode (D1) and a readout transistor (M3); many or all of these elements may be formed on or in a substrate to form the pixel circuit 836. In practice, the local region of piezoelectric sensor material of each pixel 834 may transduce received ultrasonic energy into electrical charges. The peak detection diode D1 may register the maximum amount of charge detected by the local region of piezoelectric sensor material PSM. Each row of the pixel array 835 may then be scanned, e.g., through a row select mechanism, a gate driver, or a shift register, and the readout transistor M3 for each column may be triggered to allow the magnitude of the peak charge for each pixel 834 to be read by additional circuitry, e.g., a multiplexer and an A/D converter. The pixel circuit 836 may include one or more TFTs to allow gating, addressing, and resetting of the pixel 834.

Each pixel circuit 836 may provide information about a small portion of the object detected by the ultrasonic sensor system. While, for convenience of illustration, the example shown in FIG. 8 is of a relatively coarse resolution, ultrasonic sensors having a resolution on the order of 500 pixels per inch or higher may be configured with an appropriately scaled structure. The detection area of the ultrasonic sensor system may be selected depending on the intended object of detection. For example, the detection area may range from about 5 mm×5 mm for a single finger to about 3 inches×3 inches for four fingers. Smaller and larger areas, including square, rectangular and non-rectangular geometries, may be used as appropriate for the target object.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof.

Implementations of the subject matter described in this specification also may be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that may be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those having ordinary skill in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein, if at all, to mean “serving as an example, instance, or illustration.” Any implementation described herein as “exemplary” is not necessarily to be construed as preferred or advantageous over other implementations.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

It will be understood that unless features in any of the particular described implementations are expressly identified as incompatible with one another or the surrounding context implies that they are mutually exclusive and not readily combinable in a complementary and/or supportive sense, the totality of this disclosure contemplates and envisions that specific features of those complementary implementations may be selectively combined to provide one or more comprehensive, but slightly different, technical solutions. It will therefore be further appreciated that the above description has been given by way of example only and that modifications in detail may be made within the scope of this disclosure.

1. An apparatus comprising:
an ultrasonic sensor stack configured to transmit and receive ultrasonic waves, the ultrasonic sensor stack comprising:
a transistor layer having a substrate and an array of sensor pixels;
a piezoelectric layer coupled to the transistor layer;
an electrode layer coupled to the piezoelectric layer; and
a metal layer coupled to the electrode layer, wherein the metal layer has a thickness tuned to match a peak frequency in an ultrasonic frequency range of the ultrasonic waves transmitted by the ultrasonic sensor stack.

2. The apparatus of claim 1, further comprising:
a device stack selected from the group consisting of: a display stack, a glass stack, a plastic stack, a ceramic stack, and a metal stack, wherein the ultrasonic sensor stack is underlying the device stack.

3. The apparatus of claim 2, wherein the device stack comprises the display stack.

4. The apparatus of claim 3, wherein the display stack comprises a display stiffener coupled to a foldable display, wherein an acoustic resonator is formed by at least the display stiffener, the transistor layer, the piezoelectric layer, the electrode layer, and the metal layer.

5. The apparatus of claim 4, wherein a thickness of the acoustic resonator corresponds to a multiple N of a half wavelength (N*λ/2) of the peak frequency in the ultrasonic frequency range of the ultrasonic waves transmitted by the ultrasonic sensor stack, wherein N is an integer greater than or equal to 1.

6. The apparatus of claim 4, further comprising:
an adhesive between the display stiffener and the ultrasonic sensor stack; and
a matching layer between the adhesive and the display stiffener, wherein the matching layer has an acoustic impedance value greater than the adhesive and less than the display stiffener.

7. The apparatus of claim 1, wherein the electrode layer has a thickness equal to or less than about 10 μm.

8. The apparatus of claim 1, wherein the metal layer comprises a copper layer.

9. The apparatus of claim 8, wherein a thickness of the copper layer is between about 1 μm and about 120 μm and the peak frequency in the ultrasonic frequency range is between about 2 MHz and about 20 MHz.

10. The apparatus of claim 9, wherein a thickness of the copper layer is between about 2 μm and about 18 μm and the peak frequency in the ultrasonic frequency range is between about 10 MHz and about 18 MHz.

11. The apparatus of claim 9, wherein a thickness of the copper layer is between about 20 μm and about 80 μm and the peak frequency in the ultrasonic frequency range is between about 3 MHz and about 10 MHz.

12. The apparatus of claim 1, wherein the electrode layer comprises silver ink or silver paste.

13. The apparatus of claim 1, further comprising:
an acoustic layer coupled to the metal layer, wherein the acoustic layer comprises a material having an acoustic impedance value that is less than an acoustic impedance value of the metal layer.

14. The apparatus of claim 13, wherein a thickness of the acoustic layer is tuned to optimize amplification of a signal of the ultrasonic waves.

15. The apparatus of claim 13, wherein the acoustic layer comprises polyimide (PI) or polyethylene terephthalate (PET).

16. The apparatus of claim 1, further comprising:
a conductive film layer between the metal layer and the electrode layer, wherein the conductive film layer provides electrical interconnection between the metal layer and the electrode layer; and
a polyimide layer coupled to the metal layer, wherein the metal layer comprises a copper layer, wherein the copper layer and the polyimide layer collectively form a flexible copper clad laminate (FCCL) stack.

17. The apparatus of claim 1, wherein the substrate comprises silicon, glass, or plastic.

18. The apparatus of claim 1, wherein the thickness of the metal layer is greater than a thickness of the electrode layer.

19. An apparatus comprising:
a foldable display stack comprising a display stiffener; and
an ultrasonic sensor stack configured to transmit and receive ultrasonic waves, the ultrasonic sensor stack comprising:
a transistor layer having a substrate and an array of sensor pixels;
a piezoelectric layer coupled to the transistor layer;
a silver ink electrode layer coupled to the piezoelectric layer;
a tunable copper layer coupled to the silver ink electrode layer, wherein a thickness of the tunable copper layer is greater than a thickness of the silver ink electrode layer, wherein an acoustic resonator is formed by at least the display stiffener, the transistor layer, the piezoelectric layer, the silver ink electrode layer, and the tunable copper layer; and
a polyimide layer coupled to the tunable copper layer.

20. The apparatus of claim 19, wherein the ultrasonic sensor stack further comprises:
an anisotropic conductive film (ACF) layer between the tunable copper layer and the silver ink electrode layer, wherein the tunable copper layer and the polyimide layer form a flexible copper clad laminate (FCCL) stack.

21. The apparatus of claim 19, wherein a thickness of the acoustic resonator corresponds to a multiple N of a half wavelength (N*λ/2) of a peak frequency in an ultrasonic frequency range of the ultrasonic waves transmitted by the ultrasonic sensor stack, wherein N is an integer greater than or equal to 1.

22. A method comprising:
controlling, via a control system, an ultrasonic transceiver layer of an ultrasonic fingerprint sensor stack to transmit ultrasonic waves through at least one or more display stack layers of a foldable display, wherein the ultrasonic fingerprint sensor stack comprises a transistor layer having a substrate and an array of sensor pixels, the ultrasonic transceiver layer coupled to the transistor layer, an electrode layer coupled to the ultrasonic transceiver layer, and a metal layer coupled to the electrode layer;
receiving, by the control system and from the ultrasonic fingerprint sensor stack, ultrasonic sensor signals corresponding to reflections of transmitted ultrasonic waves from a portion of a target object positioned on an outer surface of an apparatus that includes the ultrasonic fingerprint sensor stack; and
performing, by the control system, an authentication process based, at least in part, on the ultrasonic sensor signals.

23. The method of claim 23, wherein the electrode layer has a thickness equal to or less than about 10 μm, and wherein a local maximum of ultrasonic wave transmission corresponds to a frequency in a range from 1 MHz to 20 MHz.

24. The method of claim 23, wherein the authentication process involves extracting target object features from the ultrasonic sensor signals.

25. The method of claim 24, wherein the target object features include at least one of fingerprint features or sub-epidermal features.
